(19) United States
(12) Patent Application Publication
(10) Pub. No.: US 2022/0388428 A1
(43) Pub. Date: Dec. 8, 2022

(54) TRACKED ELECTRIC VEHICLE SYSTEMS

(71) Applicant: Philadelphia Scientific LLC, Montgomeryville, PA (US)

(72) Inventor: William E.M. Jones, Freeport (BS)

(21) Appl. No.: 17/648,537

(22) Filed: Jan. 20, 2022

Related U.S. Application Data
(63) Continuation-in-part of application No. 17/647,244, filed on Jan. 6, 2022, now abandoned.
Application No. 17/647,244 is a continuation of application No. 16/892,738, filed on Jun. 4, 2020, now abandoned.
Application No. 16/892,738 is a continuation-in-part of application No. 16/728,416, filed on Dec. 27, 2019, now abandoned.
(60) Provisional application No. 63/139,565, filed on Jan. 20, 2021.
(60) Provisional application No. 62/785,499, filed on Dec. 27, 2018.

(51) Int. Cl. B60M 1/30; B60M 1/02; B60K 1/00

(52) U.S. Cl. CPC B60M 1/30; B60M 1/02; B60K 1/00; B60L 53/14

(57) ABSTRACT

Electrified roadway systems include a roadway, and vehicles configured to operate on the roadway. The roadway has a base, and two electrically-conductive rails mounted on the base. One of the rails is electrically connected to a source of electric power, and the other rail is electrically connected to an electrical ground. The vehicles include non-electrically-conductive tires, and an electric motor mechanically connected to, and configured to rotate at least one of the tires to propel the vehicle along the roadway. The vehicles draw electric power from the roadway via two electrical pickups that contact the respective rails, and a retracted position at which the pickups are out of contact with the rails. A wear-resistant cover can be positioned on each of the rails. The wear resist covers can have features that maximize the contact area and the contact force between the covers and the rails.

### CROSS-REFERENCE TO RELATED APPLICATIONS

This application claims the benefit of priority to U.S. Provisional Patent Application No. 63/139,565, filed Jan. 20, 2021. This application is a continuation-in-part of U.S. application Ser. No. 17/647,244, filed 6 Jan. 2022, which is a continuation of U.S. application Ser. No. 16/892,738, filed Jun. 4, 2020, which is a continuation-in-part of U.S. application Ser. No. 16/728,416, filed Dec. 27, 2019, which claims the benefit of priority to U.S. Provisional Patent Application No. 62/785,499, filed Dec. 27, 2018. The disclosures of each of the above applications are incorporated by reference herein in their entireties.

### FIELD

The disclosed technology relates generally to electrified roadway systems, and electric vehicles configured to operate on the roadway systems.

### BACKGROUND

Battery-powered electric vehicles are gaining in popularity and use. Due to their zero emission of greenhouse gases and other airborne pollutants, electric vehicles are gaining widespread recognition as an environmentally friendly means of personal transportation that can reduce the carbon footprint of the user and combat global warming.

Electric vehicles currently use batteries as their source of electric power. Batteries provide electric vehicles with full mobility, and allow the vehicles to operate on existing roadway systems. Any battery, however, has a finite energy-storage capacity, and needs to be recharged upon being drawn down to a low charge state. Recharging can be a time-consuming process, often taking hours to accomplish. While overnight charging may be a convenient means of charging a battery after normal daily use, the need to recharge one or more times during a long-distance trip can add significantly to time required to complete the trip. Also, the need to locate and drive to a suitable charging station can further prolong the time needed to complete the trip.

Recent advances in battery technology have resulted in increases in the storage capacity of batteries, yielding improved driving ranges for electric vehicles. Even with such advances, however, any battery will have a finite limitation on its capacity to store electricity. Thus, the range of any electric vehicle using a battery as its sole power source always will be limited by the storage capacity of the battery; and long range driving, such as several hundred miles or more, still will not be possible without the need to stop and charge the battery, which can drastically reduce the average speed that can be achieved by the vehicle.

Providing power to electric automobiles and other electric vehicles during travel along a roadway can provide the vehicles with virtually unlimited range. Supplying electricity to a moving automobile or like vehicle, however, presents substantial challenges. These challenges are due, in part, to the inherently de-centralized nature of automobile travel. Specifically, an automobile by its nature provides transportation for a very limited number of people, and typically is used transport drivers and passengers directly to their desired destination. Thus, thousands or even tens of thousands of automobiles, each traveling to a different destination, may be operating on a roadway system at any given time. Electrifying a roadway system to simultaneously power such large numbers of vehicles, most of which are traveling to different places, presents challenges relating to power distribution; power management; the safety of drivers, passengers, and pedestrians; etc. Thus, some of the primary advantages of the automobile actually make it difficult to transfer power to an automobile while it is motion. Also, most countries do not permit automobiles to operate on their highways at high, or unlimited speeds, because highways, unlike railway systems, do not provide positive control, guidance, and separation of the vehicles traveling on the highway.

Although electrified railway systems have been operating successfully for decades, automobile travel is markedly different than rail travel due to the centralized nature of rail travel. For example, the TGV family of high-speed passenger trains in France carry up to several hundred people on a single train, and transport passengers between a limited number of stations. Each train draws up to several megawatts of electricity from an overhead catenary wire system; and the train's electrically-conductive metal wheels permit the underlying rails to act as a ground source, eliminating any need for a separate ground or return wire in the catenary wire system. Also, the high transmission voltages result in a relatively low current through the catenary wires. Thus, the catenary wires can have a relatively small cross-sectional area without sacrificing transmission efficiency, which in turn helps to minimize the cost of the wires. Also, the catenary wires are positioned above the train and well above the ground, keeping the wires out of the normal reach of pedestrians. An electrified roadway system for automobiles, by contrast, would need to supply relatively small amounts of electricity to thousands or tens of thousands of vehicles at the same time, with most of the vehicles traveling to different destinations; with the power-supplying means being located in proximity to the driver, passengers, and pedestrians; and with the vehicles being electrically-isolated from the ground by their non-conductive rubber or synthetic rubber tires.

### SUMMARY

The present disclosure relates generally to electrified roadway systems, and electric vehicles configured to operate on such roadway systems. In one aspect, the disclosed technology relates to electrified roadway systems having a roadway. The roadway includes a base, an electrically-conductive first rail mounted on the base, and an electrically-conductive second rail mounted on the base. The first rail is configured to be electrically connected to a source of electric power, and the second rail is configured to be electrically connected to an electrical ground.

The system also includes a vehicle having a plurality of non-electrically-conductive tires; and an electric motor mechanically connected to, and configured to rotate at least one of the tires to propel the vehicle along the roadway. The vehicle also includes a rechargeable battery electrically coupled to the electric motor and configured to power the electric motor; and a first and a second electrical pickup each being electrically connected to the electric motor and being configured to contact the respective first and second rails when the vehicle is located on the roadway. The battery is configured to receive electric power from the first rail by way of the first electrical pickup.

In another aspect of the disclosed technology, the system further includes a controller configured to regulate an amount of electric power supplied to the vehicle by way of the first rail based on a charge state of the battery of the vehicle.

In another aspect of the disclosed technology, the controller is further configured to regulate the amount of electric power supplied to the vehicle by way of the first rail based on a demand for electric power on at least a portion of the roadway system.

In another aspect of the disclosed technology, the controller is further configured to interrupt the supply of electric power to the vehicle by way of the first rail based on the demand for electric power on at least a portion of the roadway system and the charge state of the battery.

In another aspect of the disclosed technology, the battery is configured to be recharged by the electric power received from the first rail by way of the first electrical pickup.

In another aspect of the disclosed technology, the battery is further configured to provide electric power to the first rail by way of the first electrical pickup.

In another aspect of the disclosed technology, the vehicle is a first vehicle; the system further includes a second vehicle; and the controller is further configured to regulate a transfer of electric power from the first vehicle to the second vehicle by way of the first rail.

In another aspect of the disclosed technology, the system further includes an electrically-conductive third rail positioned adjacent to the first rail and configured to be electrically connected to the source of electric power; and the first electrical pickup is further configured to contact the third rail when the vehicle is located on the roadway.

In another aspect of the disclosed technology, the roadway further includes an entry lane and the third rail is located on the entry lane.

In another aspect of the disclosed technology, the third rail is positioned on a portion of the roadway located on an uphill grade.

In another aspect of the disclosed technology, the system further includes one or more power supplies electrically connected to the source of electric power and the first and second rails; and the power supplies are configured to rectify and reduce a voltage of electric power from the source of electric power.

In another aspect of the disclosed technology, the power supplies are configured to rectify and reduce the voltage of electric power from the source of electric power to about 400 volts to about 750 volts.

In another aspect of the disclosed technology, the source of electric power includes suspended power lines configured to sag between points of support of the power lines.

In another aspect of the disclosed technology, the power lines are suspended from one of insulated poles and ceramic supports.

In another aspect of the disclosed technology, the vehicle further includes a converter electrically connected to the first electrical pickup and the electric motor and configured to, during operation, convert a voltage of electric power from at least one of the power supplies to an operating voltage of the electric motor.

In another aspect of the disclosed technology, at least one of the power supplies is electrically connected to the first and second rails by way of cables located at least in part within a trench beneath the roadway.

In another aspect of the disclosed technology, each of the power supplies is spaced apart from an adjacent one of the power supplies by a distance related to a peak electric demand for a portion of the roadway located between the adjacent power supplies.

In another aspect of the disclosed technology, the system further includes a housing, and the roadway is located within the housing,

In another aspect of the disclosed technology, the system further includes a fan configured to, during operation, evacuate air form an interior volume of the housing.

In another aspect of the disclosed technology, the housing includes vents configured to permit an outflow of air from an interior volume of the housing.

In another aspect of the disclosed technology, the system includes a walkway located within the housing.

In another aspect of the disclosed technology, the base comprises reinforced concrete.

In another aspect of the disclosed technology the vehicle is configured to, during operation, steer, accelerate, and decelerate on an autonomous basis.

In another aspect of the disclosed technology, the system further includes means for maintaining directional control of the vehicle upon failure of the autonomous steering.

In another aspect of the disclosed technology, the first rail has electrically conducive first and second elements positioned in a side by side relationship; the first element of the first rail has a height greater than the second element of the first rail so that only the first element of the first rail contacts the first electrical pickup; the second rail has electrically conductive first and second elements positioned in a side by side relationship; and the first element of the second rail has a height greater than the second element of the second rail so that only the first element of the second rail contacts the second electrical pickup.

In another aspect of the disclosed technology, the systems further include a first and a second support each mounted on the base. The first rail has one or more electrically conductive elements positioned in a side by side relationship in the first support; the second rail has one or more of the electrically conductive elements positioned in a side by side relationship in the section support; and the first and second supports each have a substantially U-shaped cross section.

In another aspect of the disclosed technology, the first and second rails are pre-stressed to minimize thermally-induced expansion.

### BRIEF DESCRIPTION OF THE DRAWINGS

The accompanying drawings, which are incorporated herein and constitute part of this specification, are illustrative of particular embodiments of the present disclosure and do not limit the scope of the present disclosure. The drawings are not to scale and are intended for use in conjunction with the explanations in the following detailed description.

FIG. 1 is a schematic illustration of an electrified roadway system, and tracked electric vehicles configured to operate on the roadway system.

FIG. 2 is a schematic illustration of a track section of the roadway system shown in FIG. 1.

FIG. 3 is a perspective view of a portion of the roadway system shown in FIGS. 1 and 2, depicting one of the tracked electric vehicles operating on the roadway system.

FIG. 4 is a side view of the one of the tracked electric vehicles shown in FIGS. 1, and 3 operating on the roadway system shown in FIGS. 1-3.

FIG. 5 is a front view of one of the tracked electric vehicles shown in FIGS. 1, 3, and 4, operating on the roadway system shown in FIGS. 1-4.

FIG. 6 is a schematic illustration of various electrical components of the roadway system and the tracked electric vehicle shown in FIGS. 1-5.

FIG. 7 is a schematic illustration of an alternative embodiment of the roadway system shown in FIGS. 1-6.

FIG. 8 is a schematic illustration of another alternative embodiment of the roadway system shown in FIGS. 1-6.

FIG. 9A is a side view of an electrical pickup of the tracked electric vehicle shown in FIGS. 1 and 3-8, depicting the electrical pickup in a deployed position.

FIG. 9B is a side view of the electrical pickup shown in FIG. 9A, depicting the electrical pickup in a retracted position.

FIG. 10 is a side view of the electrical pickup shown in FIGS. 9A and 9B, depicting the electrical pickup retracting and extending to traverse a gap in a conductive rail of the roadway system shown in FIGS. 1-6.

FIG. 11 is a schematic view of an alternative embodiment of conductive rails of the roadway system shown in FIGS. 1-6.

FIG. 12 is a magnified view of the area designated “A” is FIG. 11.

FIG. 13 is a front view of an alternative embodiment of the track section shown in FIG. 2.

FIG. 14 is a perspective view of a conductive rail of the roadway system shown in FIGS. 1-6, and a protective cover configured to cover the upper surface of the rail.

FIGS. 14A and 14B are front views of alternative embodiments of the conductive rail and cover shown in FIG. 14;

FIGS. 14C and 14D are front views of other alternative embodiments of the conductive rail and cover shown in FIG. 14;

FIG. 15 is a front exploded view of another alternative embodiment of the conductive rail shown in FIG. 14, and a support for the rail.

FIG. 16 is a front view of another alternative embodiment of the roadway system shown in FIGS. 1-6, depicting roof-mounted electrical pickups on the tracked electric vehicle.

FIG. 17 is a front view of an alternative embodiment of the roof-mounted electrical pickups shown in FIG. 16.

FIG. 18 is a diagrammatic front view of another alternative embodiment of the roadway system shown in FIGS. 1-6.

### DETAILED DESCRIPTION

The following discussion omits or only briefly describes conventional features of the disclosed technology that are apparent to those skilled in the art. It is noted that various embodiments are described in detail with reference to the drawings, in which like reference numerals represent like parts and assemblies throughout the several views. Reference to various embodiments does not limit the scope of the claims appended hereto. Additionally, any examples set forth in this specification are intended to be non-limiting and merely set forth some of the many possible embodiments for the appended claims. Further, particular features described herein can be used in combination with other described features in each of the various possible combinations and permutations.

a. Introduction

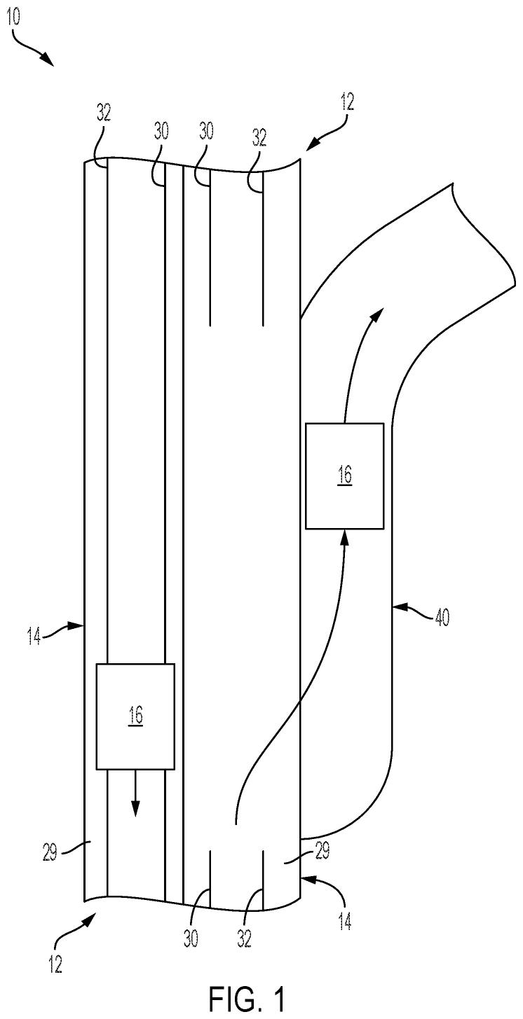

A tracked electric vehicle system 10 is disclosed. The system 10 comprises an electrified highway, or tracked electric vehicle (TEV) track 12, made up of sections of electrified track 14 as shown in FIGS. 1-3. In one possible embodiment, the system 10 can include two TEV tracks 12 located side by side, in an enclosed, semi-enclosed, or non-enclosed configuration. Non-enclosed portions of the TEV tracks 12 can include a wire fence and/or safety barriers on either side, for the safety of passengers and pedestrians.

One difference between the power supply of the system 10 and those of high-speed rail systems is that the overhead power lines of high-speed rail systems are exposed to freezing conditions, and thus can fail from time to time due to icing. The system 10 has no such exposed pantographs. In the system 10, power preferably is received by each vehicle 16 through at least one pair of contacts mounted on the underside of the vehicles and lowered automatically to make contact with, for example, extruded-aluminum power conductor rails with a stainless-steel covering to reduce wear. These rails may be installed on the TEV track 12 under the vehicle 16, or in other safe places. A suitable operating voltage for the rails may be 400 VDC (volts direct current) for the sake of personnel safety; the operating voltage can higher or lower that 400 VDC. For example, and without limitation, the operating voltage can be 750 VDC in alternative embodiments.

Supplying power from underneath the vehicle 16 can provide certain advantages. For example, this arrangement does not spoil or otherwise substantially affect the appearance of the vehicle 16. Alternative power-supply configurations, such as pantographs mounted on the roof of a vehicle, can appear unsightly, especially when the pantographs are extended to contact the overhead wires from which the pantograph draws electric power.

The system 10 also includes electrically-powered vehicles 16 configured to operate on, and draw electric power from the track 14. Being electrically powered, the system 10, in one aspect, can be viewed as an evolution of existing highway systems, and can transform limited-range electric vehicles into a new, long-range transportation system. More specifically, the system 10 can transform the use of battery-powered electric vehicles by giving such vehicles a virtually unlimited driving range using dedicated, high-speed electric tracks from which the vehicles pick up utility electric power, continuously or intermittently, via power rails which may be located safely under the vehicles. It is believed that the system 10 can make electric cars competitive with high-speed railway systems in terms of the average attainable speed, while being more flexible in where the system 10 can be located, and having substantially lower construction and operating costs. Further, it is believed that a single track of the system 10 has the capability to carry substantially more passengers per hour than a single track of a high-speed railway.

Also, the system 10 can include a power-distribution system that receives electric power, preferably from non-polluting sources such as wind farms, hydro, atomic power stations, etc., and transmits the electric power to the track 14 at a moderate voltage.

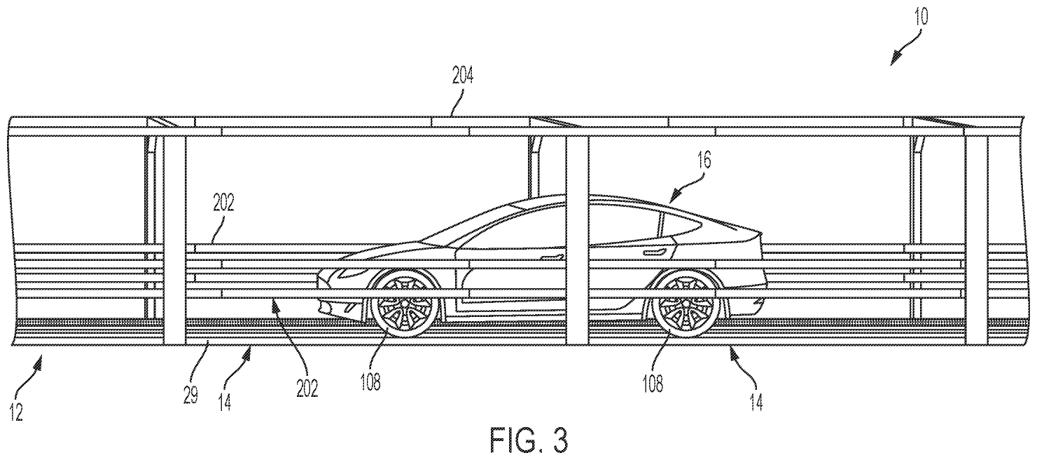

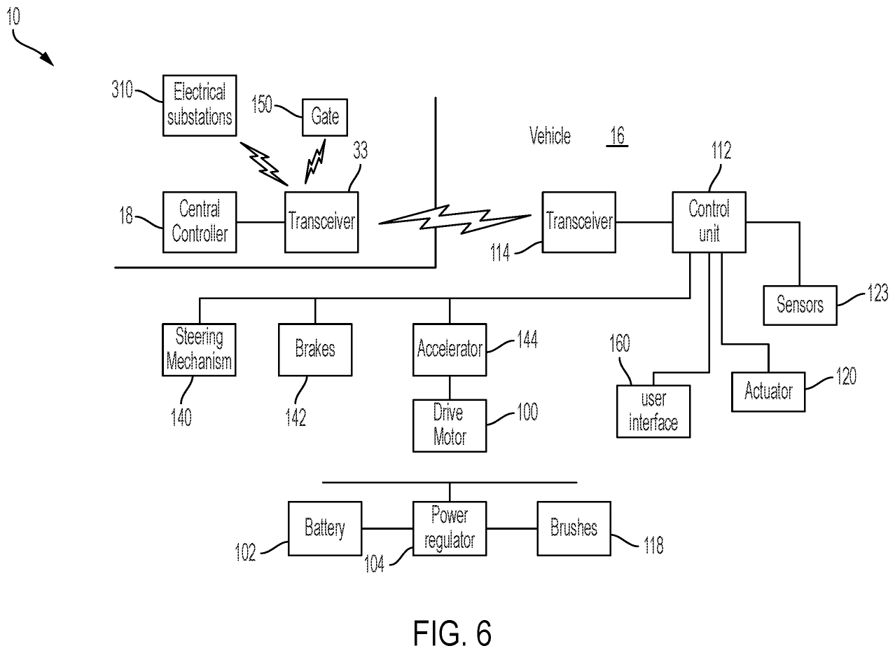

Each vehicle 16 can be equipped with conventional air-filled, rubber or synthetic rubber automobile tires 108, shown in FIGS. 3-5. The vehicle 16 also can have a steering mechanism 140, brakes 142, and an accelerator 144, as depicted schematically in FIG. 6. The steering mechanism 140, brakes 142, and accelerator 144 can be operated both by the driver; and automatically, without driver input. Thus, the vehicle 16 does not require the use of rails or other mechanical provisions to guide the vehicle 16 along the TEV track 12; and the vehicle 16 can operate off of, and independently of the TEV track 12, on conventional public roads, using its on-board battery 102 as the sole source of electric power. The TEV track 12 can be equipped with features that cause the vehicle 16 continue to operate safely in the event the vehicle 16 loses its automatic steering control. In some embodiments, the TEV track 12 can be configured prevent lateral impact of the vehicle 16 on the track side barriers if vehicle steering is lost by, for example, shaping the track surface to inhibit or prevent lateral movement of the vehicle 16; or through mechanical contact between an arm, projection, or peg on the vehicle 16 and a corresponding groove formed in the TEV track 12.

Some local cars, delivery vans, and parcel delivery vehicles, including postal service vehicles, can operate on the TEV track 12 system in an unmanned state. The unmanned vehicles can be used over short distances, i.e., on a local TEV track; or over long distances, i.e., on an express TEV track.

The vehicle 16 is configured to be controlled on a fully autonomous basis whenever the vehicle 16 is operating on the TEV track 12. The position of the vehicle 16 in relation to the TEV track 12, and in relation to other vehicles 16 operating on the TEV track 12, can be controlled via a central controller 18 of the system 10, depicted schematically in FIG. 6. Thus, while it is anticipated that a driver will be present in the vehicle 16 during most, or all of the time the vehicle is operating on the TEV track 12, the presence of a driver is not required once the controller 18 has assumed control of the vehicle 16. Multiple TEV tracks 12 can be installed in a parallel arrangement, with each of the individual TEV tracks 12 forming a lane of the system 10 as shown schematically in FIG. 1. In this particular embodiment, one TEV track 12 is dedicated to vehicular traffic traveling in one direction; and a second TEV track 12 accommodates vehicular traffic traveling in the other direction.

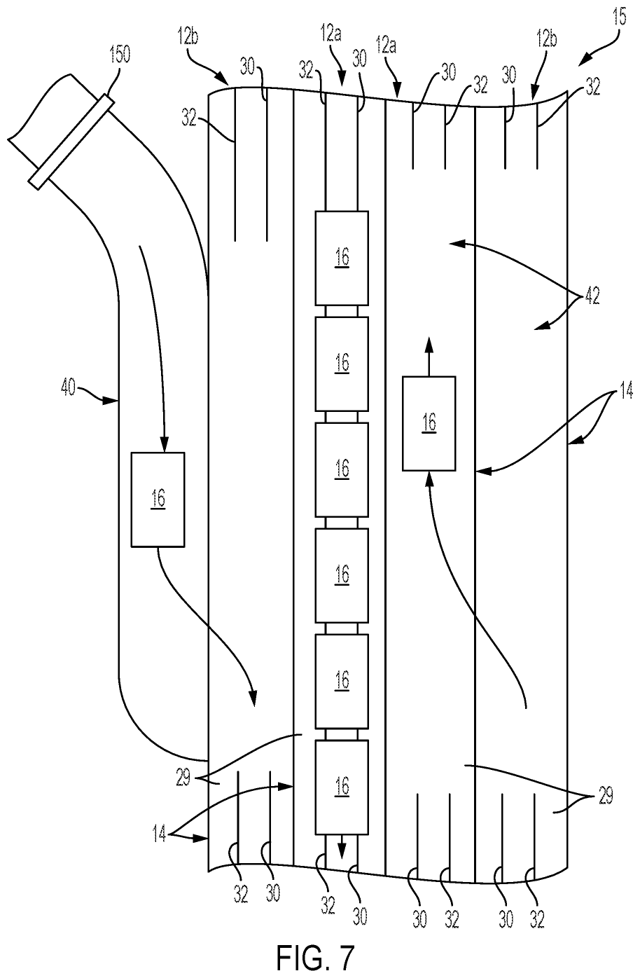

Alternative embodiments of the system 10 can include more than two TEV tracks 12, to provide multiple lanes in each direction of traffic flow. For example, FIG. 7 depicts a four-lane system 15 made up of two of the electrified TEV tracks 12 in each direction. Although the respective positions of all the vehicles 16 operating on the TEV tracks 12 can be controlled simultaneously by the central controller 18, an added margin of safety can be achieved by placing conventional crash barriers (not shown) between adjacent TEV tracks 12.

The system 15 can be configured with express and local tracks. The inner tracks can be designated express tracks 12a, and can be used by vehicles 16 traveling at high speeds, such as 120 miles per hour (193 kilometers per hour). The outer tracks can be designated local tracks 12b, and can accommodate vehicles 16 operating a lower speeds. Vehicles 16 can enter the express tracks 12a from the local tracks 12b; and the vehicles 16 can exit the express tracks 12a onto the local tracks 12b. The vehicles 16 operating on the express tracks 12a can be aerodynamically streamlined, to optimize the vehicles 16 for high-speed operation. The streamlined vehicles 16 also can operate on the local tracks 12b. Non-streamlined vehicles 16, such as compact pickup trucks, mini-buses, delivery vans, etc., can be limited to operating on the local tracks 12b. If desired, exceptions can be made for streamlined express parcel delivery vehicles to operate on the express tracks 12a, which can provide a source of revenue to help operate and maintain the system 10.

Also, because the express tracks 12a and the local tracks 12b have the same physical power delivery arrangement, vehicles 16 traveling on an express track 12a can slow down and exit the express track 12a, and then merge seamlessly onto a local track 12b leading directly, or indirectly (via a conventional road system) to a city, suburb, or other destination, such as the home of the vehicle's occupants. Thus, the system 10 can provide the occupants of the vehicles 16 with flexibility to travel at high speed, and to drive directly to their final destination. High-speed rail systems, by contrast, are still tied to stations at which the train must stop in order for the passengers to board and disembark. Electric power regenerated by the vehicle 16 as it decelerates from cruise speed to exit speed can be diverted to the battery 102 of the vehicle 16; into the TEV track 12 to power other vehicles 16; and/or to stationary batteries 312 (discussed below) located proximate the TEV track 12.

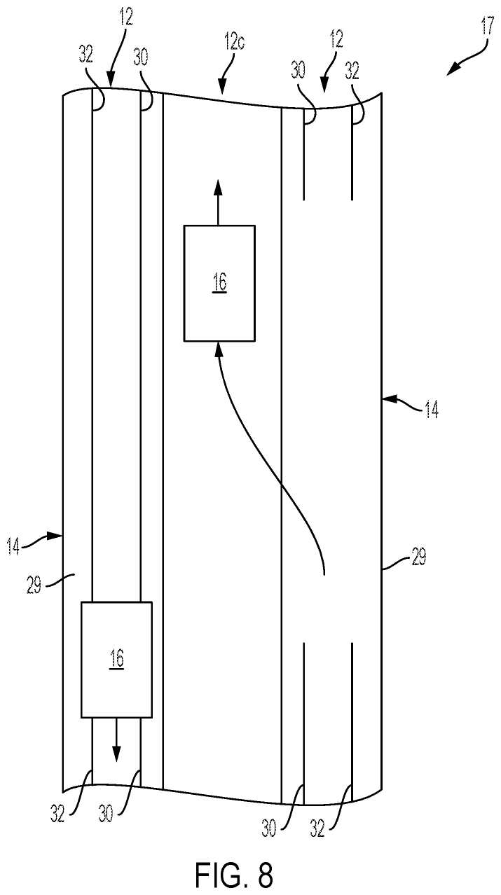

FIG. 8 depicts another alternative embodiment in the form of a system 17. The system 17 has a third, non-electrified TEV track 12c located between two of the electrified TEV tracks 12 described above in relation to the system 10. The non-electrified, or inner TEV track 12c can be used as an alternative path of travel for the vehicles 16 when sections of the outer, or electrified TEV tracks 12 are undergoing maintenance or otherwise are not available for vehicle traffic. The vehicles 16 can move onto the non-electrified TEV track 12c, and can travel on the TEV track 12c under the vehicles' own battery power when it is necessary to bypass a portion of one of the electrified TEV tracks 12, thereby ensuring that vehicle traffic can remain flowing when one of the electrified TEV tracks 12 is not available. The non-electrified TEV track 12c also can be used as a temporary travel lane during peak periods of vehicle traffic, to help alleviate traffic congestion on the TEV track 12.

Access to the TEV tracks 12 can be restricted by centrally-controlled gates 150 located at the various entrances 40 to the TEV tracks 12. One of the gates 150 is depicted schematically in FIG. 7. Thus, the TEV tracks 12 can be used at different times to accommodate traffic traveling in opposite directions. For example, a particular TEV track 12 can be used by vehicles 16 traveling toward a major city during morning commuting hours; and the same TEV track 12 can be used to accommodate vehicle traffic traveling away from the city during evening commuting hours. Due to the polarity of first and second conductors 30, 32, the vehicles 16 can be driven on the TEV track 12 in one direction only while receiving power from the TEV track 12. The vehicles 16 nevertheless can travel in the opposite direction of traffic flow a particular lane of the TEV track 12 using the vehicle's on-board batteries 102. The vehicles 16 likewise can be driven in a direction opposite the normal direction of traffic flow using their batteries 102 as the sole power source, when an emergency, repairs, or other factors make one lane of a two-lane TEV track 12 unavailable.

The system 10, and its various alternative embodiments, can be used to transport people and light freight, such as parcel freight. The vehicles 16 can be cars, small vans, and other vehicles configured to have relatively low aerodynamic resistance. These limitations help to minimize the energy requirements of the system 10. Alternative embodiments of the system 10 can be configured to accommodate larger vehicles such as semi-trailer trucks, tall delivery vans, etc. Because the vehicles 16 are non-polluting electric vehicles, the vehicles 16 do not contribute to carbon dioxide production and global warming when the electricity consumed by the vehicles 16 has been generated from a green, or non-polluting source. Thus, it is believed that widespread use of the system 10 can lead to substantial reductions in the levels of CO₂ and other greenhouse gases in the atmosphere within a few years of its introduction.

Because the vehicles 16 do not stop on the TEV track 12, the TEV track 12 can accommodate a continuous flow of vehicles 16. Also, the TEV track 12 can be configured with many exits and entrances 40 to permit a high degree of flexibility in the locations at which the vehicles 16 can enter and exit the TEV track 12. In a typical high-speed rail system, by contrast, trains must stop for at least several minutes at the stations along their routes, which can limit the capacity of the system to twelve trains or less per hour in each direction; also, the limited number of stations give passengers limited options for the locations at which they can embark and disembark the train. Furthermore, while high-speed trains may be capable of a top speed of 180 miles per hour (290 kilometers per hour), the average speed of such trains typically is about 124 miles per hour (200 kilometers per hour) or less. By contrast, because it is anticipated that vehicle traffic on the TEV track 12 can remain moving at all times at speeds of about 120 miles per hour (193 kilometers per hour), it is believed that a typical TEV track 12 can have ten or more times the passenger-carrying capacity per track or lane than a high-speed train.

Current European and Japanese high-speed trains can carry about 800 and about 1300 passengers, respectively, at speeds up to 180 miles per hour. Thus, a single accident involving such a train potentially can result in the death and injury of hundreds of people. The vehicles 16 of the system 10, by contrast, are separate vehicles all of which cannot be involved in a single devastating crash.

b. Vehicle

Each vehicle 16 can include an electric drive motor 100, a battery 102, and a power regulator 104 electrically connected to the drive motor 100 and the battery 102, as depicted schematically in FIG. 6. The battery 102 provides electric power to the drive motor 100 on a selective basis, as discussed below. The drive motor 100 is configured to operate on direct current. In alternative embodiments in which the TEV track 12 is electrified by alternating current, the drive motor 100 can be an alternating current motor; or the drive motor 100 can be a direct current motor and the vehicle 16 can be equipped with a transformer-rectifier unit to transform the alternating current from the TEV track 12 into direct current.

Because the battery 102 is a secondary power source that is used primarily when the vehicle 16 is being operated on conventional roads; and because the battery 102 can be recharged when the vehicle 16 is operating on the TEV track 12, the battery 102 can be smaller, lighter, and less expensive; and can have a longer service life than the battery of a conventional electric car. Alternative embodiments of the vehicle 16 can include more than one drive motor 100 and more than one battery 102.

Referring to FIG. 6, the vehicle 16 also includes a control unit 112, and a transceiver 114 communicatively coupled to the control unit 112. The transceiver 114 communicates wirelessly with a transceiver 33 associated with the central controller 18, via RF signals or other suitable means. The control unit 112 and the controller 18 thus communicate via the transceiver 114 and the transceiver 33. In alternative embodiments, the control unit 112 and the central controller 18 can communicate via a wired connection routed, for example, through or along-side the TEV track 12.

The control unit 112 comprises a processor, such as a microprocessor; a memory device communicatively coupled to the processor via an internal bus; and computer-executable instructions stored on the memory device and executable by the processor. The control unit 112 also comprises an input-output bus, and an input-output interface communicatively coupled to the processor by way of the input-output bus. The computer-executable instructions are configured so that the computer-executable instructions, when executed by the processor, cause the control unit 112 to carry out the various logical functions described herein. The above details of the control unit 112 are presented for illustrative purposes only. The control unit 112 can have components in addition to, or in lieu of those described above, and can have an internal architecture other than that descried above.

The control unit 112 is communicatively coupled to, and can control the operation of the steering mechanism 140, brakes 142, and accelerator 144 of the vehicle 16. The vehicle 16 can be operated manually, by the driver; or automatically, without driver input, as discussed below.

The control unit 112 can control the operation of the vehicle 16 on both a partially-autonomous basis, and a fully-autonomous basis. When operating on a partially-autonomous basis, the control unit 112 can control the direction of travel, speed, and braking of the vehicle 16; overall control of vehicle navigation, including turning onto different streets, entering and exiting highways, changing lanes, etc., remains with the driver. The partially-autonomous mode of operation can be used during operation of the vehicle 16 off the TEV track 12. Alternatively, the vehicle 16 can be controlled entirely by the driver when the vehicle 16 is being operated off the TEV track 12.

When operating on a fully-autonomous basis, the control unit 112, in conjunction with the central controller 18 of the system 10, exercises full control of the position, steering, braking, speed, and navigation of the vehicle 16 via control of the steering mechanism 140, brakes 142, and accelerator 144. This mode of operation is used only when, and whenever the vehicle 16 is being operated on the TEV track 12. Fully autonomous control is feasible under these conditions because the central controller 18 knows the locations, speeds, directions of travel, and destinations of the vehicle 16, and all the other vehicles 16 operating on the TEV track 12. The central controller 18 thus can exercise simultaneous control over all of the vehicles 16 through the respective control units 112 of each vehicle 16. The location, speed, and direction of travel of the vehicle 16 can be sensed by a GPS navigation device, or other suitable means on the vehicle 16; and can be transmitted to the central controller 18 by way of the transceiver 114 and the transceiver 33. Alternatively, or in addition, the TEV track 12 can be equipped with sensors (not shown) that detect the location, speed, and direction of travel of each vehicle 16, and relay that information to the central controller 18.

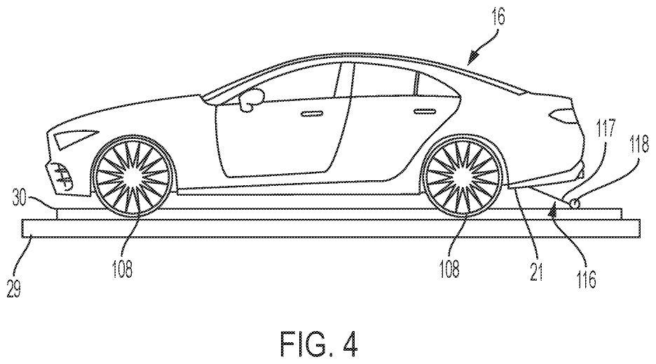

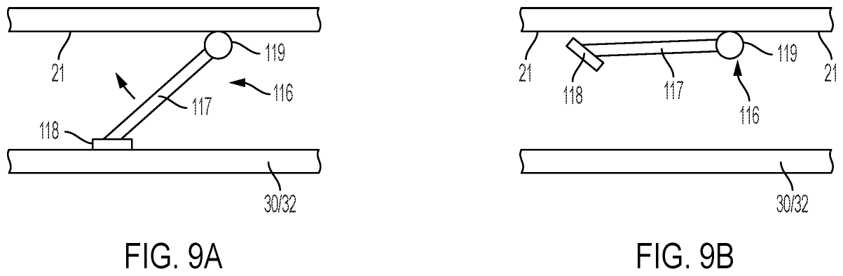

Each of the vehicles 16 can be assigned a unique identifier that is transmitted to the central controller 18, and is used by the controller 18 to track and guide each individual vehicle 16. The identifier also can be used for billing-related purposes such as monitoring the amount of energy used by a particular vehicle 16; and tracking the movement of the vehicle 16 to assess any tolls that may be due. Each vehicle 16 includes two retractable electrical pickups 116, depicted in FIGS. 4, 5, 9A, 9B, 10, and 12. The electrical pickups 116 conduct electric power between the TEV track 12 and the vehicle 16. The electrical pickups 116 are mounted on an underside 21 of the vehicle 16, in an orientation reversed, i.e., upside down, in relation to the normal orientation of a pantograph on a high-speed train. Each electrical pickup 116 can move between a lowered, or deployed position as shown in FIGS. 4, 5, 9A, 9B, and 12; and a retracted, or stowed position shown in FIG. 9B.

Each electrical pickup 116 includes an arm 117, and a brush 118. A first end of the arm 117 is connected to a rotatable coupling 119. The coupling 119 is mounted on the underside 21 of the vehicle 16, so that the arm 117 can rotate in relation to the underside 21 as shown in FIGS. 9A and 9B. The coupling 119 is electrically insulated from its mounting surface. The arm 117 is formed from a rigid, electrically-conductive material such as aluminum. The arm 117 is electrically connected to the power regulator 104 of the vehicle 16 by way of a cable (not shown) or other suitable means. An actuator 120, shown schematically in FIG. 6, is coupled the arm 117, and provides the force needed to move the arm 117.

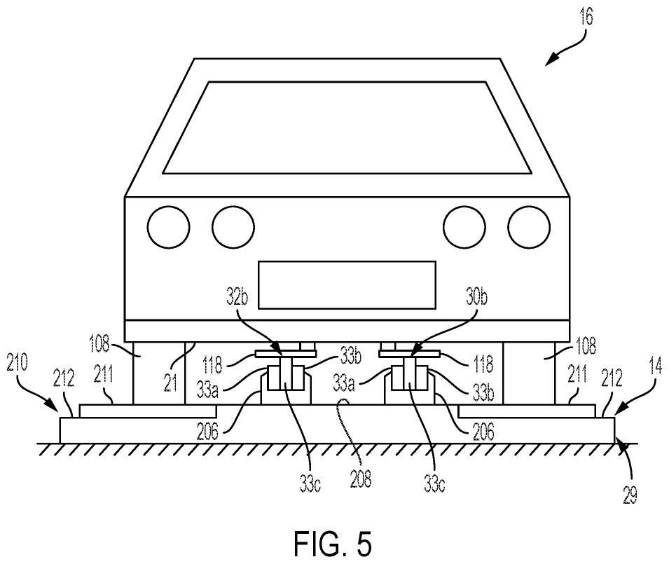

The brush 118 is secured to a second end of the arm 117, and extends in a direction substantially perpendicular to the longitudinal axis of the arm 117. Each brush 118 contacts an upper surface of an electrically conductive first or second rail 30, 32 of the TEV track 12, when the electrical pickups 116 are in their deployed position. The brushes 118 are elongated, as shown in FIG. 5; and are oriented to extend in a direction substantially perpendicular to the first or second rail 30, 32 when the vehicle 16 is traveling on the TEV track 12, so that the brushes 118 can maintain contact with the first or second rails 30, 32 as the vehicle 16 drifts from side to side during normal travel.

The brushes 118 can be formed from carbon; the brushes 118 can be formed from other electrically-conductive materials in the alternative. Each brush 118 is electrically connected to the power regulator 104 of the vehicle 16 by way of its associated arm 117, and the cable that electrically connects the arm 117 to the power regulator 104. The electrical pickups 116, when in their deployed position, establish electrical contact between the vehicle 16 and the first and second rails 30, 32, and thereby permit electric current to flow between the vehicle 16 and the TEV track 12. As can be seen in FIG. 9B, when in the retracted position, the electrical pickups 116 are located out of close proximity to the TEV track 12 and the ground, thereby permitting the vehicle 16 to operate on conventional roadways without interference between the electrical pickups 116 and the roadway.

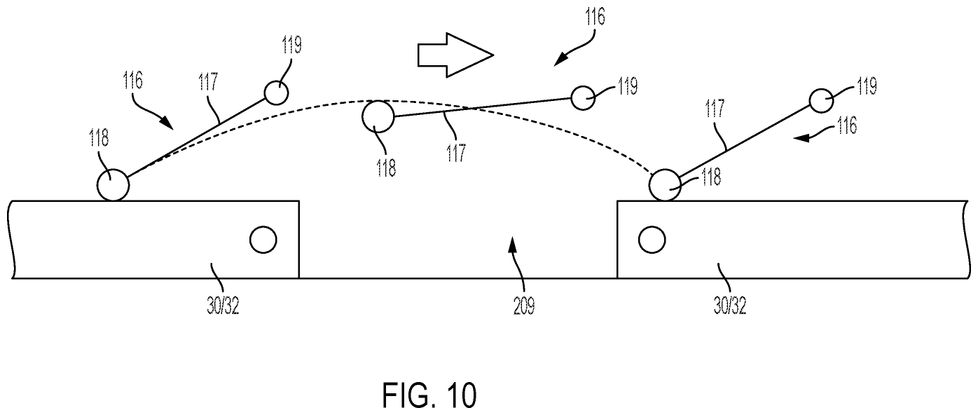

The actuators 120 can be communicatively coupled to, and controlled by the control unit 112 of the vehicle 16, so that the control unit 112 can command the extension and retraction of the electrical pickups 116. The commands can be generated by the control unit 112 automatically, or in response to inputs from the driver. For example, as discussed below, the control unit 112 can automatically command the extension and retraction of the electrical pickups 116 to cause the electrical pickups 116 to “jump” over a damaged portion of the first or second rails 30, 32; or to jump over a gap between the first or second rails 30, 32 of adjacent track sections 30, 32, as depicted in FIG. 10.

The electrical pickups 116 can be configured to extend in a consistent, predetermined manner. For example, the control unit 112 can be configured to command the actuator 120 to undergo its full deflection during extension of the electrical pickup 116. Alternatively, a force sensor (not shown) can be mounted on the arm 117 or the actuator 120, and can be communicatively coupled to the control unit 112. The control unit 112 can use the reading from the force sensor to continuously control the position of the actuator 120 so as to cause the brush 118 to contact the first or second rail 30, 32 with a consistent force sufficient to ensure adequate power transfer to the vehicle 16, but low enough to avoid excessive wear of the brush 118 and/or the first or second rail 30, 32.

In alternative embodiments, shoes or other suitable contacting means for transferring power between the vehicle 16 and the first and second rails 30, 32 can be used in lieu of the brushes 118. Also, the actuator 120 can be further configured to cause the electrical pickups 116 to slowly oscillate side to side, i.e., in a direction substantially perpendicular to the first and second rails 30, 32, when the electrical pickups 116 are in their deployed position, to help equalize wear on the brushes 118. The above-noted configuration of the electrical pickups 116 is disclosed for illustrative purposes only; the electrical pickups 116 can have other configurations in alternative embodiments.

The maximum power consumption of the vehicle 16, when powered by direct current as described herein, is estimated to be about 40 kilowatts (kW) when the vehicle 16 is traveling at 120 miles per hour (193 kilometers per hour). It is believed that this amount of power can be transferred by a brush 118 having an overall contact area of only about 0.9 square inches (about six square centimeters). This relatively low level of required power transfer is a result of the decentralized power management inherent in the use of relatively small, stand-alone vehicles 16 each propelled by its own drive motor 100. High-speed trains, by contrast, typify centralized power management in a transportation vehicle. The peak power transfer to a high-speed train can be as high as several megawatts, which necessitates a larger and more complex power-transfer interface and power management system than that required by the vehicle 16.

The system 10 can be equipped with security measures to enhance the safety, security, and confidence of drivers and passengers. Because the system 10 and the vehicles 16 are centrally controlled, it is believed that such security measures can be implemented with relative ease, with little or no inconvenience to drivers and passengers, and with minimal added expense.

For example, the vehicles 16 can be equipped with a facial recognition system that ties the vehicle 16 to its owner or to a pre-approved driver, thereby reducing the risk that stolen vehicles 16 will be driven onto the system 10. Also, drivers of rented vehicles 16 can be made to undergo a security check at the rental counter, before the driver is given access to the vehicle 16. The check can include taking photographs of the driver; and obtaining approval for the driver from a data base to verify, for example, that the driver is licensed and is not subject to any outstanding warrants. Also, the system 10 can be configured to initiate a telephone call directly to the driver. The call can be made by a machine or a human, and the driver can be asked a salient question about his or her trip to help verify that that the driver intends to use the roadway system 10 for a legitimate, legal purpose. Also, rental vehicles 16 and other vehicles not being operated by or on behalf by the owner can be equipped with a sniffer located, for example, in the trunk of the vehicle 16, to detect contraband or explosives. Other types of security checks can be evolved over time.

Automobiles driven in countries with left hand drive, such as the United Kingdom, India, and Japan, can be operated on the system 10 without any restrictions of limitations, although the implementation of a universal right-hand-drive law may be preferred at some time in the future.

c. TEV Track

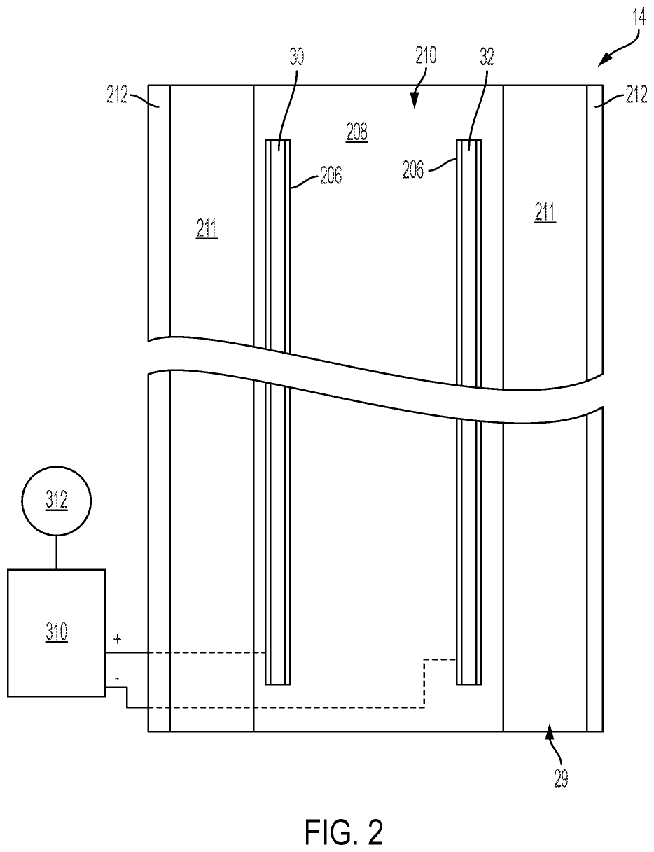

Each TEV track 12 preferably is constructed on a modular basis, from individual sections of electrified track 14. Referring to FIGS. 2 and 5, each track section 14 includes an elongated base 29, the first electrically-conductive rail 30, and the second electrically-conductive rail 32. The track sections 14 are arranged end to end to form a single TEV track 12. The track sections 14 preferably are manufactured as modules; and can be assembled in the field by attaching adjacent track sections 14 to each other, and to the ground, using conventional techniques known in the road-construction industry.

The base 29 can be formed from a durable, high-strength, relatively low-cost material. For example, each base 29 can be made from reinforced concrete covered with tarmac. Alternatively, the base 29 can be formed from sheet steel strips coated with tungsten carbide grit. The strips can be cut at a slant in 50-foot (15-meter) sections, and can be bolted down onto suitable anchors. The strips can be replaced when worn by automated pick and place machines. The base 29 can be formed from other materials in the alternative.

The first and second rails 30, 32 are mounted on the base 29, as discussed in detail below. The first and second rails 30, 32 are elongated rails each having a substantially rectangular cross section. The first and second rails 30, 32 can have other types of cross sections, and other overall configurations in alternative embodiments. The first rail 30 provides electric power to the vehicle 16, while the second rail 32 provides a return path, or ground, for the electric current. This two-conductor arrangement is necessary because the vehicle 16 has rubber or synthetic rubber tires 108 that, in contrast to the metal wheels of an electrically-powered train, do not provide a return path for the electric current supplied to the vehicle 16. In alternative embodiments, the second rail 32 can provide electric power to the vehicle 16, while the first rail 30 acts as a ground.

As can be seen in FIG. 5, the first and second rails 30, 32 are located beneath the vehicle 16 when the vehicle 16 is traveling on the TEV track 12. In alternative embodiments, the first rail 30 and the second rail 32 can be positioned in other locations in relation to the vehicle 16. For example, the first and second rails 30, 32 can be positioned in a wall-mounted configuration in which the first and second rails 30, 32 are located to the side of the vehicle 16.

The first and second rails 30, 32 each can have a length of about 2,460 feet (about 750 meters). The first and second rails 30, 32 can have a length that is greater, or less than this value. Longer-length rails, in general, will have a lower cost per unit length than comparable shorter rails, but the longer length can make the rails difficult to transport, store, and handle. Also, longer-length rails may need to be formed from a more expensive, higher-conductivity material than shorter rails, to offset the greater resistive losses associated with transmitting electricity over the increased length of the longer rails.

Referring to FIG. 3, each track section 14 can include an enclosure or housing 200 that spans the entire length of the track section 14. The housing 200 has two side panels 202 mounted on opposite sides of the base 29; and a roof panel 204 mounted on, and supported by the side panels 202. The roof panel 204 can be solid, to inhibits rain, snow, leaves, and other foreign objects from falling onto the roadway surface. The side panels 202 can be formed as a series of rails that inhibit pedestrians, animals, and unauthorized vehicles from entering the roadway, while providing drivers and passengers with a view outside of the housing 200. Restricting access to the roadway and sheltering the roadway from the elements can enhance safety, and can permit the vehicles 116 to travel at faster speeds than otherwise would be possible. The roof panel 204 and the side panels 202 can have other configurations in alternative embodiments. For example, the side panels 202 can be solid in alternative embodiments. In other embodiments, the roof panel 204 and the side panels 202 can be formed as a unitary tubular structure. Also, solar panels can be installed on the roof panel 204 and/or the side panels 202, to help power the system 10. For clarity of illustration, the roof panel 204 and side panels 202 are shown in FIG. 3 only. Walkways (not shown) can be provided within the housing 200 on one or both sides of the vehicle path, to facilitate access to the TEC track 12 by maintenance personnel. The walkways also can provide a means for passengers to exit the TEV track 12, if necessary, via emergency exits (also not shown) provided in the housing 200.

In embodiments of the system 10 in which the housing 200 is moderately or fully airtight, the system 10 can be equipped with exhaust fans (not shown) that evacuate some in the air inside the housing 200, thereby reducing aerodynamic drag for all vehicles 16 operating on the TEV track 12 within the housing 200. This feature can reduce the power consumption and operating cost of the vehicles 16. Vehicles 16 operating in this partial vacuum can use ram-air or pumps to pressurize the cabins of the vehicles 16 to a level comfortable for the occupants. The fans also can be used to vent smoke from inside the housing in the event of a fire within the housing.

Referring to FIGS. 2 and 5, the base 29 of each track section 14 has an upper surface 210. The upper surface 210 includes a middle portion 208, and two outer portions 212 that each adjoin the middle portion 208. The middle portion 208 is elevated in relation to the outer portions 212, as can be seen in FIG. 5. The upper surface 210 can have other configurations in alternative embodiments.

The first and second rails 30, 32 are mounted in respective supports 206. The supports 206 are secured to the middle portion 208 of the upper surface 210 of the base 29, by a suitable means such as fasteners (not shown). The supports 206 can be formed from a high-strength material, such as steel, coated with an electrically-insulating material. The supports 206 can have a U-shaped cross section, as shown in FIG. 5, so that the first and second rails 30, 32 are accessible, or open, from above. The supports 206 can have other shapes, and can be formed from other materials, in the alternative. Electrically-insulating barriers or strips (not shown) can be positioned adjacent the first and second rails 30, 32, to reduce the potential for accidental human contact.

The first and second rails 30, 32 are restrained from vertical movement in relation to their associated support 206 by their own weight, and by friction between the contacting vertical surfaces of the support 206 and the first and second rails 30, 32. In alternative embodiments, the supports 206 can be equipped with provisions to restrain the first and second rails 30, 32 vertically, while permitting the first and second rails 30, 32 to move longitudinally, i.e., in the lengthwise direction, to accommodate thermally-induced expansion of the first and second rails 30, 32 in relation to the supports 206. Such restraint can be provided, for example, by bolts (not shown) that span width of the supports 206. The bolts can extend through circular holes in opposite sides of the supports 206, and through longitudinally-oriented slots in the first and second rails 30, 32. The orientation of the slots permits the first and second rails 30, 32 to move longitudinally in relation to the bolt and the support 206, while the bolt and the support 206 prevent substantial movement of the first or second rail 30, 32 in the vertical direction. The middle portion 208 of the upper surface 210 of the base 29 has provisions that promote the drainage of the middle portion 208, to prevent accumulation of water and other liquids around the first and second rails 30, 32. These provisions can take the form of, for example, channels or drain holes (not shown).

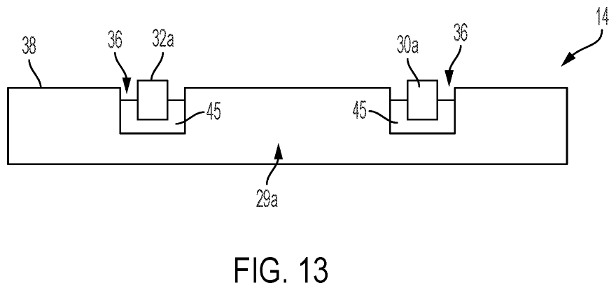

Each track section 14 also includes two friction strips 211. The friction strips 211 are secured to the respective outer portions 212 of the upper surface 210 of the base 29, and shown in FIGS. 2 and 5. The friction strips 211 form the surfaces of the TEV track 12 that contact the tires 108 of the vehicles 16, and can be formed from a durable, wear-resistant material having a relatively high coefficient of friction. The first and second rails 30, 32 of alternative embodiments can be mounted in ways other than that described above. For example, FIG. 13 depicts an alternative embodiment in which first and second rails 30a, 32a are mounted in respective longitudinal slots or channels 36 formed in a base 29a, using a suitable means such as brackets or fasteners. The channels 36 can be sized so that an upper surface of each of the first and second rails 30a, 32a is positioned higher than an upper surface 38 of the base 29a, by an amount sufficient to permit reliable contact between the upper surfaces of the first and second rails 30a, 32a, and the brushes 118 of the vehicle 16. The space between each of the first and second rails 30, 32 and the adjacent surfaces of the base 29 can be filled with an electrically-insulating material 45.

In other alternative embodiments (not shown), the first and second rails 30, 32 can be mounted on insulators that are secured to, and positioned above the upper surface 210 of the base 29. This non-recessed mounting arrangement can help to reduce stray electrical currents under wet conditions.

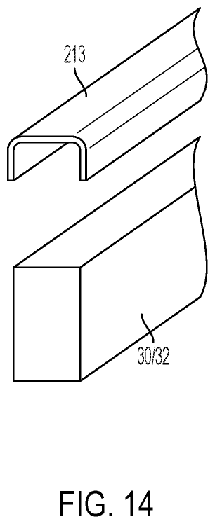

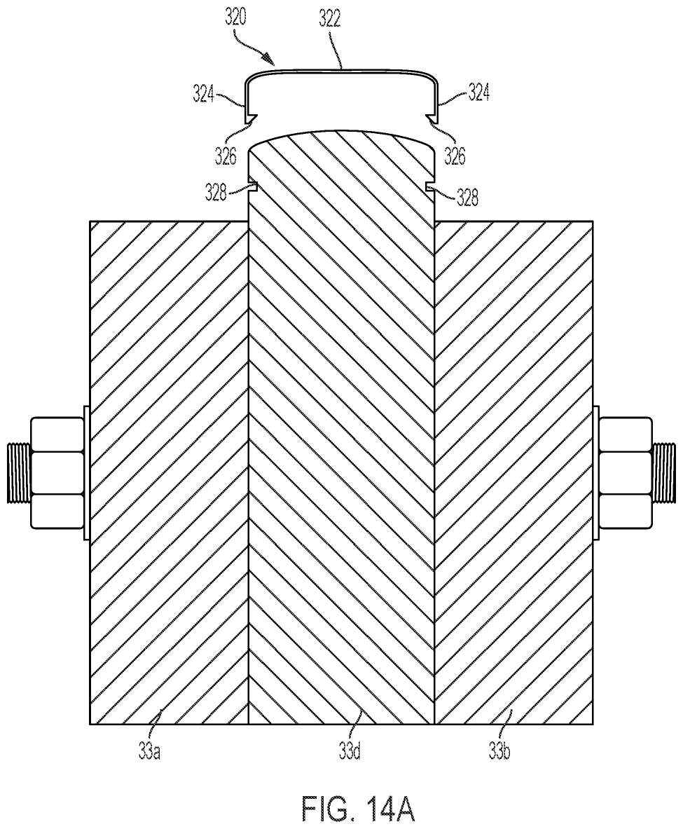

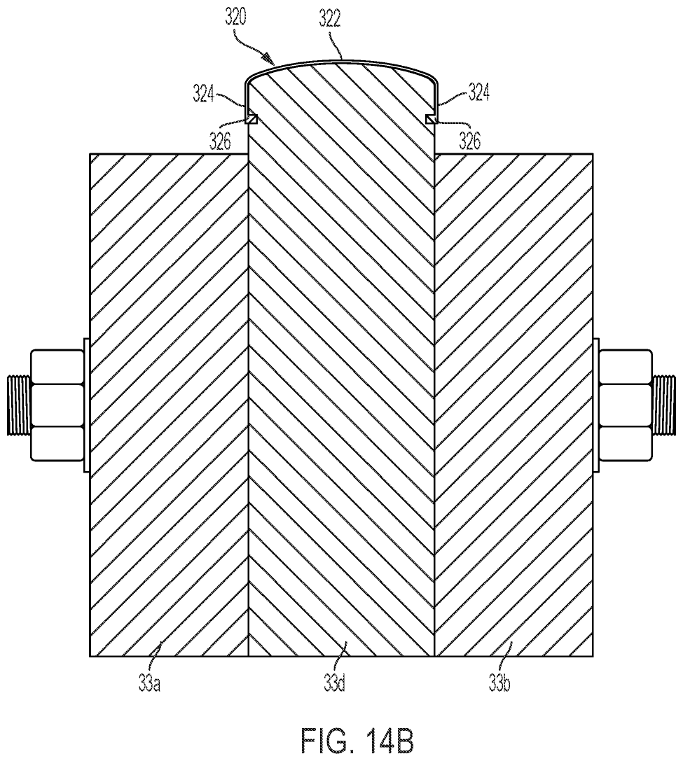

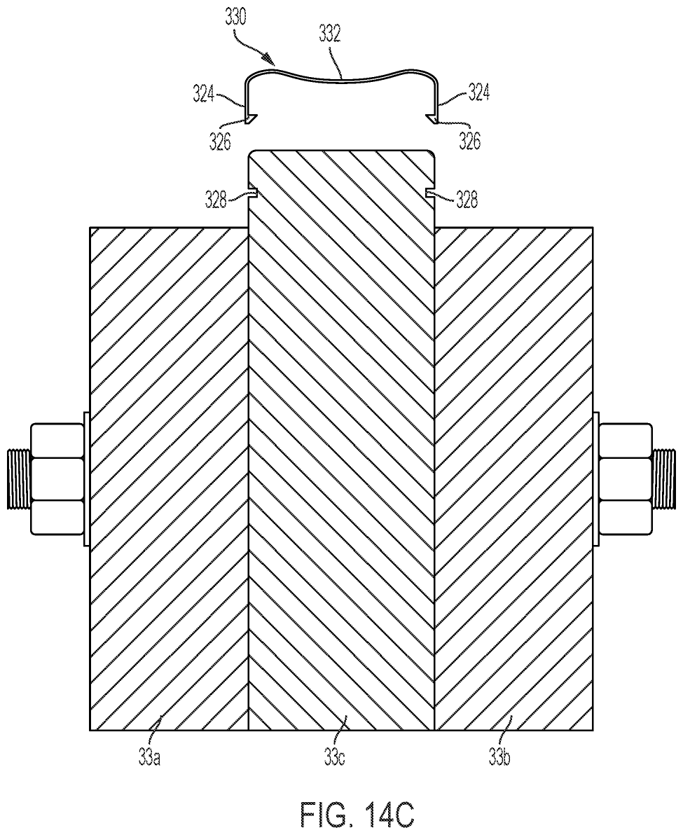

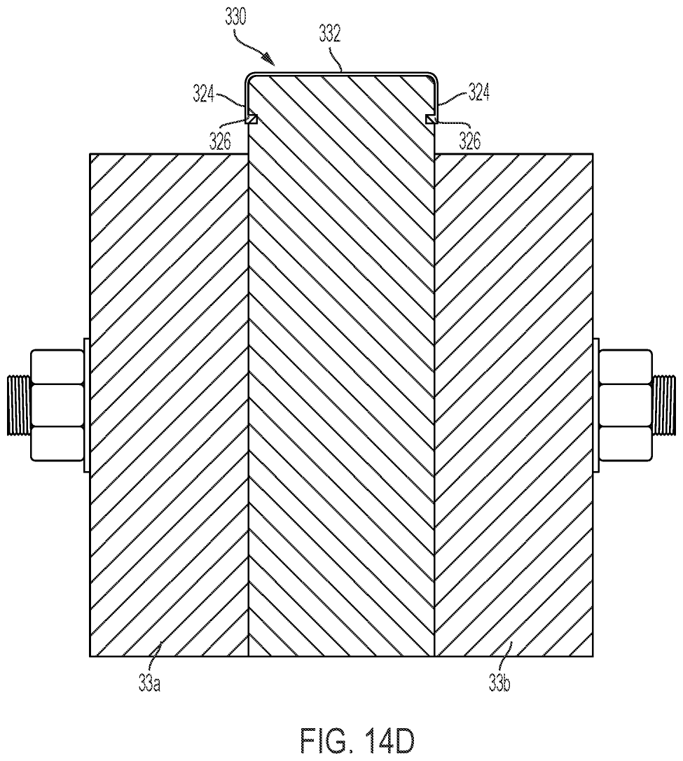

The first and second rails 30, 32 can be formed from an electrically-conductive material such as copper, aluminum, steel, etc. While aluminum is less expensive than copper and steel, aluminum is less resistant to the normal wear that can result from the movement of the brushes 118 over the first and second rails 30, 32. The rate of such wear may be acceptable due the relatively low contact forces between the brushes 118 and the first and second rails 30, 32 in comparison to the contact forces exerted by, for example, a typical electrical pickup on a high-speed train. If it is necessary or otherwise desirable to reduce the wear rate on the first and second rails 30, 32, however, such reductions can be achieved, for example, by coating the upper, or contact surfaces of the first and second rails 30, 32 with a relatively hard, wear-resistant material such as stainless steel; by installing a protective covering, formed from a relatively hard, wear-resistant material, on the contact surfaces; or by forming the first and second rails 30, 32 from an aluminum alloy with greater wear resistance than pure aluminum. For example, FIG. 14 depicts a self-locking, stainless-steel protective cover 213 that can be installed on the first and second rails 30, 32 to protect the underlying aluminum from wear.

It is believed that the cost of the first and second rails 30, 32, when formed from aluminum with a stainless-steel coating or covering, will be less than half the cost of comparable conductors formed from steel or copper. Also, aluminum is readily available, and can be formed into desired shapes through a relatively simple extrusion process that can be performed in most countries throughout the world. Also, the use of aluminum allows the first and second rail 30, 32 to be recycled upon reaching the end of their service life.

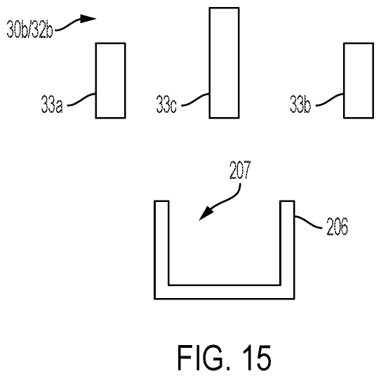

Each of the first and second rails 30, 32 can be formed as a single piece, as depicted, for example, in FIG. 14. FIGS. 5 and 15 depict an alternative embodiment of the first and second rails 30, 32 in the form of first and second rails 30b, 30b. The first and second rails 30b, 32b have a modular construction. In particular, the first and second rails 30b, 32b each are formed from three separate electrically-conductive elements. A first and a second of the elements, designated 33a and 33b respectively, have a vertical dimension, or height, that is less than the height of the third element, designated 33c. The third element 33c is depicted in FIGS. 5 and 15 as being positioned between the first and second elements 33a, 33b. The third element 33c can be positioned to the right, or left of both of the first and second elements 33a, 33b in the alternative. The first, second, and third elements 33a, 33b, 33c are secured to each other by a suitable means such as bolts or other types of fasteners (a bolt suitable for this purpose is depicted in FIGS. 14A-14D).

FIGS. 14A and 14B depict alternative embodiments of the third element 33c and the stainless steel cover 213 in the form of, respectively, an electrically-conductive element 33d and a stainless steel cover 320. The cover 320 comprises a top portion 322, two side portions 324 that adjoin opposite sides of the top portion 322, and two clips 326. Each clip 326 adjoins a respective one of the side portions 324, and extends inwardly and upwardly from the side portion 324 when the cover 213 is not positioned on the electrically-conductive element 33d, as can be seen in FIG. 14B. The top portion 322, side portions 324, and clips 326 are unitarily formed. The top portion 322, side portions 324, and clips 326 can be formed separately, and can be connected by a suitable means such as welding in alternative embodiments. The electrically-conductive element 33d has two longitudinally-extending detents, or grooves 328 formed therein, on opposite sides of the element 33d. Each groove 328 receives a respective one of the clips 326 of the cover 320. The clips 326 flex and snap into their respective grooves 328 during assembly and securely engage the element 33d, as shown in FIG. 14B, so that interference between the clips 326 and the element 33d retains the cover 320 on the element 33d. The center portion 322 forms the contact area between the cover 320 and the brushes 118 of the vehicle 16.

The upper surface of the electrically-conductive element 33d has an outwardly curved, or convex shape, as shown in FIGS. 14A and 14B. The cover 320 is configured so that the center portion 322 is substantially planar when the cover 320 is not installed on the element 33d, as shown in FIG. 14A. Also, the cover 320 is thin enough to permit the center portion 322 to flex and conform to the shape of the upper surface of the element 33d when the cover 320 is installed on the element 33d, as can be seen in FIG. 14B. The flexing of the center portion 322 and the clips 326 causes the cover 320 and the clips 326 to generate a spring force that helps to maintain secure contact between the clips 326 and the element 33d; and between the center portion 322 of the cover 320 and the upper surface of the element 33d. Also, the conformance of the center portion 322 to the shape of the upper surface of the element 33d causes a substantial entirety of an inner surface of the center portion 322 to contact the upper surface of the element 33d. This maximal contact maximizes the contact area between the center portion 322 and the upper surface of the element 33d, which in turn helps to maximize electrical conductivity between the element 33d and the cover 320. Electrical contact between the cover 320 and the element 33d can be further enhanced by the use of an electrically conductive cement between the cover 320 and the element 33d.

FIGS. 14C and 14D depict an alternative embodiment of the cover 320 in the form of a stainless-steel cover 330. The cover 330 is adapted for use with an electrically conductive element 33e having a substantially planar upper surface. The cover 330 comprises a top portion 332. The cover 330 also includes two of the side portions 324, and two of the clips 326 described above in relation to the cover 320. The side portions 324 adjoin opposite sides of the top portion 332. Each clip 326 adjoins a respective one of the side portions 324. The clips 326 flex and securely engage grooves 328 formed in the element 33e when the cover 330 is installed on the element 33e, as can be seen in FIG. 14D. The top portion 332, side portions 324, and clips 326 are unitarily formed. The top portion 332, side portions 324, and clips 326 can be formed separately, and can be connected by a suitable means such as welding in alternative embodiments.

The top portion 332 has an inwardly curved, or concave shape when the cover 330 is not installed on the element 33e, as shown in FIG. 14C. The cover 330 is thin enough to permit the center portion 332 to flex and conform to the planar shape of the upper surface of the element 33e when the cover 330 is installed on the element 33e, as can be seen in FIG. 14D. As discussed above in relation to the cover 320, the flexing of the center portion 332 and the clips 326 helps to maintain secure contact between the clips 326 and the element 33e, and between the center portion 332 and the upper surface of the element 33e; and maximizes the contact area between the center portion 332 and the upper surface of the element 33e.

The self-conforming covers 320, 330 can be particularly advantageous in applications, such as the system 10, in which the external force exerted on the covers 320, 330 is relatively light. In the system 10, the light contact force exerted by the brushes 118 does not substantially increase the contact area or the electrical conductivity between the covers 320, 330 and the underlying electrically-conductive elements 33d, 33e. By contrast, trains that draw power from an electrified rail often draw power through a single large shoe that contacts the electrified rail with a substantial contact force. In applications where a stainless-steel wear cover is used to cover the electrified rail, the substantial contact force exerted by the shoe can be sufficient to maintain satisfactory mechanical and electrical contact between the cover and the underlying rail. In the system 10, by contrast, the relatively light contact force exerted by the brushes 118 of each individual vehicle 16 is too small to reliably deflect a stainless steel cover. The covers 320, 330 address this potential issue by self-generating a substantial contact force between the covers 320, 330 and the respective electrically-conductive elements 33d, 33e. The covers 320, 330 thus can permit the use of aluminum rails without the wear-related issues normally associated with such rails, and without the electrical-conductivity issues that can result from the use of a stainless-steel wear cover in a light duty, i.e., low-contact-force, application.

The covers 320, 330 are described in connection with a three-element modular conductor for illustrative purposes only. The covers 320, 330 can be used in connection with single-piece conductors; and with modular conductors having less, or more than three electrically-conductive elements. Also, the covers 320, 330 can be formed from relatively hard, wear-resistant materials other than stainless steel.

The support 206 defines a space, or volume 207 that accommodates the elements 33a, 33b, 33c (or 33d) of the first and second rails 30b, 30b. The volume 207 has a width that is approximately equal to the combined width of the first, second, and third elements 33a, 33b, 33c, so that the first, second, and third elements 33a, 33b, 33c are restrained from substantial lateral, or side-to-side movement, in relation to the support 206.

High ambient temperatures can cause the rails of high-speed railway systems result to expand and buckle, which in turn can result in a high-speed derailment. And global warming is increasing the risk of such accidents. To avoid such buckling during hot summer weather, the steel rails of high-speed railways are deliberately heated in the field using special equipment, to a temperature above the expected maximum local ambient temperature; and are then clamped and cooled. This essentially “freezes” the expansion into the steel so that the rail does not shrink back and buckle in service when the ambient temperature rises to a high level.

The system 10 does have the above problems relating to thermal expansion because the system 10, unlike high-speed railway systems, does not include steel rails. While the elements 33a, 33b, 33c can be formed from aluminum, the elements 33a, 33b, 33c carry no vehicle weight and therefore do not need to be treated in the same manner as the steel rails of a high-speed railway system.

The elements 33a, 33b, 33c are restrained by the support 206 in the longitudinal, or lengthwise direction by an amount sufficient to permit the elements 33a, 33b, 33c to resist longitudinal movement in response to friction with the brushes 118 of the electrical pickups 116, while allowing the elements 33a, 33b, 33c to expand and contract in the longitudinal direction in response to changes in temperature. The longitudinal restraint of the first and second rails 30b, 32b can be provided, for example, by friction between the contacting surfaces of the support 206 and the first and second rails 30b, 30b. If necessary, excessive movement of the first and second rails 30b, 32b in the longitudinal direction can be prevented by the optional bolts that engage the supports 206, and the horizontally-oriented slots in the first and second rails 30b, 32b as discussed above.

If necessary, the supports 206 and the first and second rails 30b, 32b can be equipped with friction-reducing features that facilitate longitudinal deflection of the first and second rails 30b, 32b, to help ensure that the first and second rails 30b, 32b can expand and contract in response to changes in temperature. For example, the first and second rails 30b, 32b can rest on rollers; and/or an anti-friction coating can be applied to the contacting surfaces of the supports 206 and the first and second rails 30b, 30b.

Alternatively, the first and second rails 30, 32 can be pre-heated and pre-stressed, as described above in relation to the steel running rails of high-speed railways. Unlike the rails of high-speed railways, however, the first and second rails 30, 32 can be treated during extrusion in a factory, and not during construction in the field. This procedure will retain the first and second rails 30, 32 at a constant length, in a manner similar to the pre-stressed rails of the high-speed railway. However, the treatment of the first and second conductors 30, 32 will be done with a less expensive process, specifically, by clamping the ends of the hot first and second rails 30, 32 immediately after extrusion, and then cooling the first and second rails 30, 32 in-situ to prevent shrinking. This process is believed to be a quicker, less expensive, and easier way to pre-stress the first and second conductors 30, 32 in comparison to the process performed on the steel rails of high-speed railways. Therefore, if necessary or preferred, the first and second conductors 30, 32 can be pre-stressed in a cost-effective manner, so as to remain at a constant length after installation in the field.

In very cold climates, the copper wires used on high-speed railways, such as the TGV, can become coated with ice, damaging the train's pantograph. The system 10 and the vehicles 16 do not have any exposed outdoor pantographs, and thus are immune such potential problems. In alternative embodiments of the system 10 in which power is supplied from pole-mounted overhead lines, it is believed that such lines will suffer none of the problems of expansion and contraction that befall the copper power wires of high-speed railways. First, the overhead lines of the alternative embodiment of the system 10 do not need to be tensioned. Even in extreme heat and cold, these pole-mounted aluminum wires simply will expand and contract without stress. And these power wires preferably are aluminum overhead wire, delivered to the construction site on reels. This is among the lowest-cost options for any application of the system 10, and uses existing installation methods that are familiar worldwide. This embodiment of the system 10, therefore, has the ability to supply large amounts of electric power with substantial reliability, and without concern for the seasonal expansion and contraction of the overhead wires.

Because the third element 33c of the first and second rails 30, 32 has a greater height than the first and second elements 33a, 33b, the electrical pickups 116 contact the first and second rails 30, 32 exclusively by way of the third elements 33c, as can be seen in FIG. 5. The first and second elements 33a, 33b, therefore, do not need to be equipped with a wear-resistant coating or cover. Thus, the areas of contact on the first and second rails 30b, 32b, and the expense of coating or covering those areas, are minimized; while the combined cross-sectional area of the first and second rails 30b, 32b can remain large enough to permit the first and second rails 30b, 32b to conduct relatively large amounts of electric power without overheating. The use of three conductive elements 33a, 33b, 33c is disclosed for illustrative purposes only; the number of conductive elements in each of the first and second rails 30b, 32b can be varied to accommodate the maximum rated current for the first and second rails 30b, 32b in a particular application. Also, the multiple conductive elements can have equal heights in alternative embodiments.

Because the current-carrying capacity of the first and second rails 30b, 32b is related to the number of individual conductive elements within each of the first and second rails 30b, 32b, the current-carrying capacity can be tailored to the requirements for a particular section of the TEV track 12 by varying the number of conductive elements. For example, a greater number of conductive elements can be used on uphill sections of the TEV track 12, where the power requirements of the vehicles 16 are relatively high. Conversely, a lesser number of conductive elements, or no conductive elements at all, can be used on downhill sections, where power requirements are lower. The ability to tailor the current-carrying capacity of the first and second rails 30b, 32b in this manner can help avoid the unnecessary expenditure of capital resulting from equipping portions of the TEV track 12 with greater current-carrying capacity than necessary.

Also, this modular configuration for the first and second rails 30b, 32b can facilitate expansion of the TEV track 12 to accommodate increases in traffic volume over time. For example, the first and second rails 30b, 32b each can be equipped with only one conductive element when the system 10 initially is brought on line and the traffic volume is expected to be relatively low. Additional elements can be added as the traffic volume, and the associated power requirements, increase over time. For example, an initial increase in traffic can be accommodated by adding a second conductive element. If the conductive elements are two inches (five centimeters) wide by four inches (ten centimeters) tall, the addition of the second conductive element would increase the respective cross-sectional areas of the first and second rails 30b, 32b from eight square inches to 16 square inches (103 square centimeters), and would double the currently-carrying capability of the first and second rails 30b, 30b. Further increases in traffic could be accommodated by adding a third conductive element, increasing the cross-sectional areas of the first and second rails 30b, 32b to 24 square inches (155 square centimeters). The relatively wide, unobstructed area beneath the vehicle 16 can facilitate the installation of additional conductive elements to accommodate further increases in traffic volume.

Thus, the initial capital expenditure for the system 10 can be tailored to the anticipated initial traffic volume, instead of requiring an initial outlay of capital for traffic capacity that may not be needed until well into the future, if ever. Also, vehicles powered by internal combustion engines can be allowed to operate on the system 10 during its initial period of operation; and the revenue collected from the operators of such vehicles can be used to finance expansion of the system 10.

As can be seen in FIG. 5, the underside 21 of the vehicle 16 is smooth and unobstructed, and the relatively large area between the vehicle's tires 108 can accommodate substantial expansion of the first and second rails 30b, 30b. In such an expandable roadway, wider supports 206 can be installed when additional conductive elements are added. Alternatively, supports 206 that are wide enough to accommodate additional conductive elements can be installed initially; and inexpensive, non-conductive spacers or other means can be placed in the volume 207 to fill out the volume 207 in the lateral direction, and to support and secure the single conductive element in place until additional conductive elements are added.

Also, the relative flexibility of the thin conductive elements 33a, 33b, 33c allows the conductive elements to be bent into shallow curvilinear shapes by hand, or with simple tooling. Curved sections of the TEV track 12 can be formed, for example, by placing one of the conductive elements 33a, 33b, 33c, such as the third conductive element 33c, on a curved base 29; shaping the third conductive element 33c into a desired shape; and then securing the third conductive element 33c in position on the base 29. The first and second conductive elements 33a, 33b then can be secured to the third conductive element 33c, and to the base 29. The ability to easily form the first and second rails 30, 32 into curved shapes in this manner can help minimize the different types of conductive elements that that need to be procured, and maintained in inventory, as the roadway 10 is constructed.

The power supply system of the system 10 is substantially different from that used on high-speed rail systems. High-speed rail systems trains typically deliver power via two high-voltage 25 k VAC (volts alternating current) power wires made from 15 mm diameter copper. The wires are electrically connected in parallel, with one wire suspended from the other above the train. Both wires are held in longitudinal tension by a complex system of heavy weights and pulleys located about every 1,500 meters along the length of the wires. The power wires supply all the power to the drive motors and electronic controls of the train. Power transfer between the wires and the train usually occurs via a single large pantograph mounted on the train. The return path of the current to a substation occurs partly or wholly though the steel rails upon which the train travels.

The power supply system of the system 10 is substantially different from the power supply system of a high-speed railway system. The system 10 has no steel rails upon which the vehicles 16 travel. Instead, the vehicles 16 have rubber or synthetic rubber tires that run on road-like surfaces; and power is supplied to and returned from the vehicles 16 by way of the first and second aluminum rails 30, 32 located beneath the vehicles 16. Unlike the overhead catenary of an electrified rail system, the first and second rails 30, 32 (and their alternative embodiments) are supported from below along their entire length; and the surfaces that contact the electrical pickups 116 face upward. Thus, there is no need to tension the first and second rails 30, 32, using large weights and pulleys or other measures, to prevent the first and second rails 30, 32 from sagging. Also, due to the positive lateral restraint provided by the supports 206, the first and second rails 30, 32 do not move substantially in the lateral, i.e., side to side, direction; and can adhere very closely to the curvature of the roadway. In the TGV high-speed rail system, by contrast, a 0.6 inch (15 millimeter) overhead copper power wire has two grooves so that it can be supported by clamps hung from a catenary wire and drop wires located every few meters. The power wire requires this support to prevent it from sagging; thus, the power and catenary wires always are under a powerful and controlled tension provided by large and unsightly weights and pulleys mounted on trackside poles.

Thermally-induced expansion and contraction of the first and second rails 30, 32 (and their alternative embodiments) can be accommodated by providing a gap 209 between the ends of the first rails 30 of adjacent track sections 14; and another gap 209 between the ends of the second rails 32 of the adjacent track sections 14. The gaps 209 are depicted in FIG. 10. Each gap 209 can be, for example, about 80 inches (about two meters). A gap 209 of this magnitude may be necessary to accommodate the longitudinal deflection of the first and second rails 30, 32 that can result from changes in the ambient temperature; from internal heating of the first and second rails 30, 32 caused by the transmission of electric current; and from friction between the first and second rails 30, 32 and the brushes 118 of the first and second electrical pickups 116.

The gap 209 can be achieved by sizing the first and second rails 30, 32 so that each end of the first and second rails 30, 32 is located about 40 inches (about one meter) from the adjacent end of its associated base 29, as depicted in FIG. 2. The base 29 is not expected to undergo significant thermally-induced expansion and contraction because it will be under cover and not heated by the sun in most applications; and because the base 29 can be formed from materials, such as concrete covered in tarmac, that do not undergo substantial thermally-induced expansion and contraction. Thus, a substantial gap is not needed between the bases 29 of adjacent track section 14; and the surfaces of the TEV track 12 that contact the tires 108 of the vehicle 16 are substantially continuous along the length of the TEV track 12.

Also, the gaps 209 electrically isolate each first rail 30 from its adjacent first rails 30; and electrically isolate each second rail 32 from its adjacent second rails 32. As discussed below, this feature can allow portions of the TEV track 12 to be de-energized, while other portions of the TEV track 12 remain energized and able to accommodate vehicle traffic.

The vehicle 16 can be configured so that the electrical pickups 116 are partially retracted, or raised, on a momentary basis, by an amount sufficient to prevent the brushes 118 from contacting the exposed ends of the first and second rails 30, 32 on either side of the gaps 209. This feature can help to prevent damage to the brushes 118 that otherwise could occur when the brushes 118 contact the exposed ends of the first and second rails 30, 32. The sequential raising and lowering of one of the electrical pickups 116 as the pickup 116 traverses the gap 209 is depicted in FIG. 10, with the path of the brushes 118 denoted by the dashed line.

The retraction and subsequent extension of the electrical pickups 116 can be controlled electronically, by the control unit 112 of the vehicle 16. The control unit 112 can be provided with information regarding the positions of the gaps 209 by, for example, physical or electronic markers located at a predetermined distance from the gaps 209. The vehicle 16 can be configured with suitable sensors (not shown) for sensing the presence of the markers. Upon sensing a marker, the control unit 112 can command the electrical pickups 116 to partially retract by, for example, about one-half inch (about 1.3 centimeters). The control unit 112 can command the electrical pickups 116 to return to their deployed positions once the electrical pickups 116 have traversed the gap 209. The “deploy” logical command can be issued, for example, after a predetermined time interval; this interval can be adjusted, i.e., shortened or lengthened, based on the speed of the vehicle 16, to help minimize the time over which the brushes 118 are out of contact with the first and second rails 30, 32. For example, if one-tenth of a second is required to retract the electrical pickups 116 and another one-tenth of a second is required to re-deploy the electrical pickups 116, and the vehicle 16 is traveling at 120 miles per hour (193 kilometers per hour), the vehicle 16 will travel at least 33 feet (10 meters) before contact is restored with the first and second rails 30, 32. The on-board battery 102 of the vehicle 16 can prevent the motor 100 and other electrical components of the vehicle 16 from dropping off line during the momentary interruption of power to the vehicle 16 as the electrical pickups 116 traverse the gaps 209.

The automatic retraction and extension of the electrical pickups 116 also can be applied to avoid contact between the electrical pickups 116 and damaged sections of the first and second rails 30, 32. The control unit 112 can be configured to raise the electrical pickups 116 when a sensor (not shown) on the vehicle 16 detects damage to the first or second rail 30, 32; or when the vehicle 16 is notified by the central controller 18 of the location of such damage. The control unit 112 can be configured to automatically report the location of the damage to the central controller 18, so that corrective action can be undertaken, and other vehicles 16 on the TEV track 12 can be notified of the location of the damage. Allowing the electrical pickups 116 to “jump” over damaged sections of the first and second rails 30, 32 in this manner can prevent damage or premature wear of the brushes 118, and other portions of the electrical pickups 116, that otherwise could result from contact with the damaged conductor sections.

In the alternative, the TEV track 12 and the electrical pickups 116 can be equipped with mechanical provisions (not shown) that: lift the electrical pickups 116 as the electrical pickups 116 approach a gap 209; maintain the electrical pickups 116 in a partially retracted position as the electrical pickups 116 traverse the gap 209; and return the electrical pickups 116 to their deployed positions after the electrical pickups 116 have traversed the gap 209.

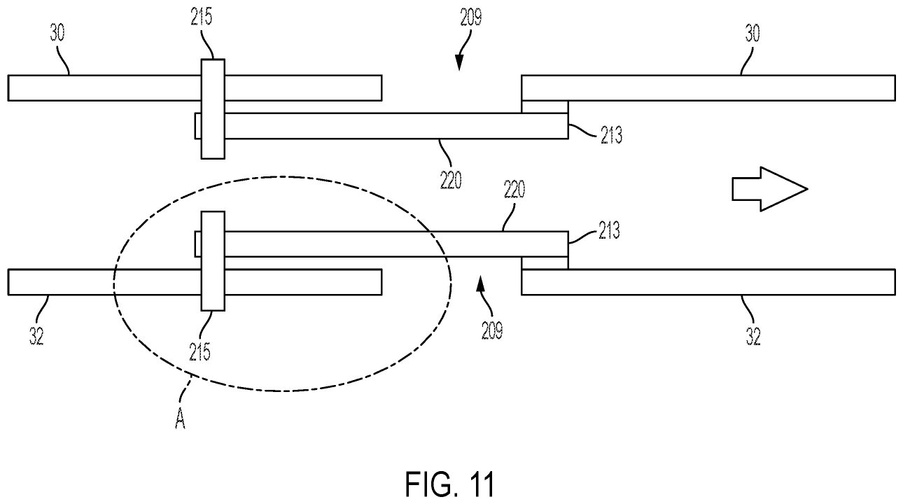

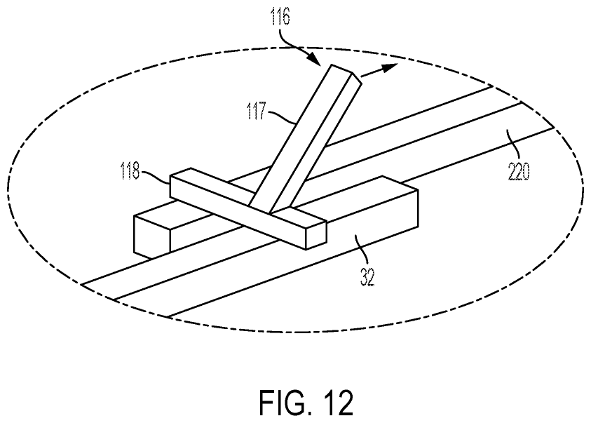

FIGS. 11 and 12 depict an alternative embodiment in which the gaps 209 are spanned by relatively short electrically-conductive rails 220, so that there is no interruption in the power being supplied to the vehicle 16. A first end of each short rail 220 is securely connected to one of the first or second rails 30, 32 by way of an electrically conductive coupling 213. A second end of the short rail 220 is connected to the adjacent first or second rail 30, 32 by way of an electrically-insulating coupling 215. The coupling 215 is configured to slide on the adjacent first or second rail 30, 32, to facilitate relative movement between adjacent first rails 30, and between adjacent second rails 32.

As can be seen in FIG. 11, the end portions of the first and second rails 30, 32 attached to the electrically-insulating coupling 215 overlap their associated short rails 210 in the longitudinal direction, so that the brushes 118 of the electrical pickups 116 remain supplied with electric power at all times during which the electrical pickups 116 traverse the gaps 209. In addition, this approach eliminates any need to retract the electrical pickups 116 as the pickups 116 traverse the gaps 209. Also, because the coupling 215 is electrically insulating, each first rail 30 is electrically isolated from its adjacent first rails 30; and each second rail 32 is electrically isolated from its adjacent second rails 32.

Because each of the first and second rails 30, 32 is electrically isolated from the first and second rails 30, 32 of adjacent track sections 14, portions of the TEV track 12 can be de-energized on a selective basis, while other portions of the TEV track 12 remain powered and capable of accommodating vehicle traffic. The ability to de-energize sections of the TEV track 12 not being used can lead to cost savings resulting from decreased consumption of electricity. For example, during periods of low vehicle traffic, such as late night, the central controller 18, which monitors the locations of every vehicle on the TEV track 12, can automatically de-energize sections of the TEV track 12 on which no vehicles 16 are present, while maintaining power to portions of the TEV track 12 on which any vehicles 16 are traveling. The controller 18 can be configured to energize the track sections 14 on which any vehicles 16 are located, and the track section 14 immediately ahead of the vehicles 16, to ensure that the vehicles 16 remain powered by the TEV track 12 at all times. A particular track section 14 can be energized and de-energized through commands, issued by the central controller 18 to an individual electric power supply 310 associated with that track section 14, to cut-off or restore power to the first rail 30 of the track section 14.

The ability to de-energize select portions of the TEV track 12 also can be used, for example, to de-energize sections 14 of the TEV track 12 on which a stopped vehicle 16, or a vehicle 16 with an open passenger door, window, or other exterior access point is located; damaged sections 14 of the TEV track 12; and sections 14 of the TEV track 12 undergoing maintenance.

The vehicles 16 can be configured so that the exterior access points of the vehicles 16 normally are locked in their closed positions when the vehicles 16 are located on the TEV track 12, thereby preventing drivers and passengers from exiting their vehicle 16 while the vehicle 16 is on the TEV track 12. Each vehicle 16 can transmit status information to the central controller 18. The status information can include, for example, an identifier unique to each vehicle 16; the location and speed of the vehicle 16; and an indication whether all of the exterior access points of the vehicle 16 are closed and locked. The controller 18 can be programmed to de-energize one or more sections 14 of the TEV track 12 upon receiving an indication that a vehicle 16 located on or near those sections 14 is stopped, and/or has one or more open exterior access points. This feature can reduce or eliminate the electrocution hazard to drivers and passengers who exit their vehicle 16 while the vehicle 16 is on the TEV track 12.

The vehicles 16 can be equipped with one or more sensors 123 that detect the presence of fire and smoke in or around the vehicle 16. The sensors 123 also can be installed on the TEV track 12. The sensors 123 can be the communicatively coupled to the central controller 18, as shown schematically in FIG. 6. A fire on a TEV track 12 can initiate, for example, in the battery 102 of a vehicle 16. A battery fire, with its enormous release of smoke, can present an extreme hazard to drivers and passengers; and a full-scale fire in a lithium-ion battery can be unstoppable with present firefighting methods due to the flammable electrolyte of such batteries. The central controller 18 can be configured so that, upon detection of smoke or fire by one or more of the sensors 123 in or proximate a particular vehicle 16, the central controller 18 will guide that vehicle 16 so as to expel the vehicle 16 from the TEV track 12 at the next exit. The central controller 18 subsequently will direct the vehicle 16 to a predetermined station, or “safe place;” and will stop the vehicle 16 and unlock the exterior access points once the vehicle 16 has reached the safe place so that the driver and passengers can exit the vehicle 16 to safety.

d. Power Delivery

The power supply device for a conventional railway usually is referred to as a substation, which reduces the very high voltage of the electricity delivered by the utility company to the various lower voltages required by different trains. These substations essentially are large transformer/rectifiers typically installed by the electrical utility; and are spaced apart in relatively large intervals along the railway.

In some embodiments of the system 10, the DC power for the TEV tracks 12 tracks is provided through relatively simple power conversion hardware referred to herein as power supplies 310, to differentiate the power supplies 310 from the substations used in railway systems. Such substations typically are buildings or other large structures that house far bigger and more complicated systems than the unmanned power supplies 310 of the system 10.

The power supplies 310 are compact transformer/rectifier units that, for example, convert high-voltage AC power from the local electric grid or other sources into a lower DC voltage that can be used to power the electric drive motors 100 inside the vehicles 16. More specifically, the power supplies 310 transform and rectify high-voltage AC power, such as 125 k VAC, to a voltage, such as 750 VDC or 400 VDC, that is low enough to be relatively safe for maintenance workers and others in direct proximity to the TEV track 12, but high enough to permit the vehicles 16 to operate efficiently. The transformer/rectifier units of the power supplies 310 can be located inside ventilated and fireproof steel enclosures. The power supplies 310 can be located anywhere along the TEV tracks 12, at any interval or spacing suited to the electrical load on a particular section 14 or sections 14 of the TEV track 12.

The power supplies 310 are shown in FIGS. 2 and 6. Each power supply 310 can provide power to an associated track section 14. Each power supply 310 is electrically connected to the first and second rails 30, 32 of its associated track section 14, as illustrated in FIG. 2. As noted above, each track section 14 of the exemplary system 10 includes one continuous first rail 30 and one continuous second rail 32, each having a length of about 2,460 feet (about 750 meters). Thus, each power supply 310 supplies power to one corresponding set of 750-meter-long continuous first and second rails 30, 32 of the TEV track 12. When two or more TEV tracks 12 are arranged side by side as shown, for example, in FIGS. 1, 7, and 8, one power supply 310 can be used to supply electric power to the first and second rails 30, 32 of adjacent, i.e., side by side, track sections 14 of the multiple TEV tracks 12. Each power supply 310 can be communicatively coupled to the central controller 18 of the system 10 by a suitable means such as radio-frequency (RF) transmission, Wi-Fi, a wired connection, etc.

Each power supply 310 supplies direct current power to the first rail 30 at, for example, 400 volts, to match the operating voltage of many current electric vehicles. The vehicle 16 draws power from the first rail 30 by way of the electrical pickup 116 in contact with the first rail 30. The second rail 32 acts as a ground that, along with the associated electrical pickup 116, completes the circuit between the vehicle 16 and the power supply 310. In alternative embodiments, the power supply 310 can supply power to the second rail 32; and the first rail 30 can act as a ground that completes the circuit between the vehicle 16 and the power supply 310.

According to Ohm's Law, the voltage drop along the first conductor 30 that supplies electric power to the vehicle 16 is proportional to the distance between the vehicle 16 and the nearest power supply 310. A similar problem has existed in railway systems for many years. Unlike in a railway system, however, the vehicle 16 can compensate for the voltage drop using its on-board battery 102. Specifically, the battery 102 can add a minimal amount of voltage to the traction or drive motor 100 of the vehicle 16, so that the motor terminals are maintained at a near-constant voltage. It is believed that this feature can help to maintain the speed of the vehicle 16 at a uniform level for a smoother drive, at minimal cost. Also, the ability to compensate for the voltage drop using the battery 102 of the vehicle 16 can allow the power supplies 310 to be located farther apart than otherwise would be feasible, which in turn can reduce the capital cost of the system 10.

The power supplies 310 can be mass produced to help minimize their cost. This can be a significant difference between train systems and car systems. Most of the components used in railway and aircraft production are not mass produced. This limitation is largely responsible for the enormous cost of building train systems such as high-speed rail systems. By contrast, most road cars are mass produced, and their costs are much lower due to their mass production. The reluctance to mass-produce high-speed rail systems and aircraft likely will not change because the consequences of component and system failures inn trains and aircraft are so high that any changes risking such consequences are preferably and deliberately avoided. For example, modern trains may carry 800 passengers (TGV, France) or 1300 passengers (Shinkansen, Japan) at 180 mph, and each train takes over 4 kilometers to stop. By contrast, the individual vehicles 16 of the system 10 can stop in 200 meters, or about twenty times less than the stopping distance of the noted trains.

Mass-produced automobiles essentially are disposable. The manufacturing cost is lowered in each new generation of automobiles through small but substantial improvements. The risk of making a component or system change, therefore, is relatively low. It is believed that the vehicles 16 of the system 10 will inherit this process, and mass production will be a basis for the continuing growth of electric vehicles, in general, throughout the world.

The system 10, therefore, can combine the advantages of mass production, lowered costs, and flexible power distribution to create a commercial, road-based, high-speed mass transit system. The mass-produced power supplies 310 can be small; can be transported, installed and commissioned routinely; and are expected to be lower in cost per unit of power than the large substations of railway systems. The power supplies 310 can be located virtually anywhere along the TEV track 12, and can be connected to the first rail 30 of the TEV track 12 at the specific location at which each power supply 310 is positioned.

As a general rule, the number of power supplies 310 connected to a TEV track 12, or to a particular portion of a TEV track 12, should be increased as vehicle traffic increases. For example, additional power supplies 310 can be added between the existing power supplies 310, to reduce the interval or spacing between the power supplies 310 and thereby increase the available power for that portion of the TEV track 12 in response to an increased power demand due to increases in vehicle traffic.

The power supplies 310, in general, need to provide more power to vehicles traveling uphill on the TEV track 12, in comparison to vehicles 16 traveling downhill. Thus, in a typical installation comprising two TEV tracks 12 accommodating vehicles 16 traveling in opposite directions, the demand for electric power on the downhill TEV track 12 will be very low, or non-existent. Because each TEV track 12 will draw the amount of electric power required to service the vehicles 16 traveling on that particular TEV track 12, and power is supplied to both TEV tracks 12 by a common power supply 310, most or all of the power provided by the power supply 310 automatically will be available to the uphill TEV track 12. It is believed that the flexibility provided by this design can reduce the capital, or start-up cost of the system 10. And even greater cost savings can be achieved by eliminating the first and second conductors 30, 32 on downhill sections, and at all exists, of the TEV tracks 12.

The system 10 can be configured to supply power at voltages greater, or less than 400 VDC; and can be configured to operate on alternating current in lieu of direct current. The voltage and the type of current are application dependent upon, and can vary with factors such as the power requirements of the vehicles 16 that will be operating on the system 10. For example, the system 10 may be configured to be compatible with the battery voltage the chosen by the companies that manufacture the vehicles 16, within limits.

Charging many different types of car batteries having different voltages can be done from a fixed-voltage power supply 310 by using a DC to DC converter located in each vehicle 16. The DC to DC converter will convert the track voltage to the battery voltage, whatever the battery voltage happens to be. For example, if the track voltage is 750 VDC and the battery voltage of the vehicle 16 is 400 VDC, the DC to DC converter in the vehicle 16 will perform the voltage conversion; and no major changes need to be made by the vehicle maker or the battery maker for the vehicle 16 to be compatible with the system 10. Modern DC to DC converters are very efficient and have a relatively low cost. Thus, the use of DC to DC converters in the vehicle 16 can provide flexibility to operate a new generation of electric vehicles on the system 10. Also, the use of alternating current to power the system 10 can be accommodated, if necessary.

Another possibility is that car makers agree to make all electric vehicle batteries with different capacities but to one standard voltage, such as 400 VDC, to make the vehicles compatible with static high-capacity chargers. The system 10 readily can be adapted to this option.

Thus, the supply voltage in the system 10 can be greater or less than the 400 VDC specified herein; for example, alternative embodiments of the system 10 can operate at voltages of 750 VDC or 1,000 VDC, although voltages of 750 VDC or less are considered generally safer for maintenance workers and others in close proximity to the TEV tracks 12.

Because each power supply 310 supplies one track section 14, the spacing between adjacent power supplies 310 is about equal to the lengths of the individual first and second rails 30, 32. As discussed above, increasing the lengths of the first and second rails 30, 32 can necessitate forming the first and second rails 30, 32 from a higher-conductivity, and more expensive, material; and can make it difficult to transport, store, and handle the first and second rails 30, 32. On the other hand, longer-length rails increase the spacing between the power supplies 310, thereby reducing the costs associated with procuring, installing, and maintaining the power supplies 310. Thus, because the optimal length for the first and second rails 30, 32 is dependent upon these, and possibly other competing factors, the optimal length can vary between applications.

As noted above, the TEV track 12 is configured to operate on direct-current (DC) electric power, with supply voltages as high as 1,000 VDC or greater. It is believed that this relatively high voltage can be used safely, i.e., with a low risk of electrocution to humans, due to the above-noted provisions that de-energize all or a portion of the TEV track 12 when a vehicle is stopped on the TEV track 12, or when a door or other exterior access point of a vehicle 16 on the TEV track 12 is opened; and because the TEV track 12 has provisions that restrict pedestrians from entering onto the TEV track 12.

The relatively high DC voltage, which results in a lower current flow through the first and second rails 30, 32, provides greater operating efficiency in comparison to a system that operates at a lower voltage, and can reduce the required size, and cost, of the first and second conductors 20. Operating voltages for DC-powered passenger trains, by contrast, typically do not exceed 750 VDC due to the proximity of the ground-mounted power-supply rail to humans.

In alternative embodiments, the vehicle 16 can be configured to operate on alternating current (AC) provided via the first and second rails 30, 32, or via AC induction hardware on the TEV track 12 and the vehicle 16. In such applications, the vehicle 16 can be equipped with a transformer-rectifier unit to transform the alternating current into direct current having a voltage, such as 400 VDC, suitable for the electric drive motor 100 and other electrical components of the vehicle 16.

The relatively high voltages that can be provided to an AC system can yield high operating efficiencies; and can reduce capital costs for the system 10 by allowing the first and second rails 30, 32 to have a smaller cross-sectional area in comparison to the conductors in a lower-voltage, higher-current DC system of similar capacity. These advantages, however, can be offset by the requirement for a transformer-rectifier unit to transform the AC power into the lower-voltage DC power suitable for powering the drive motor 100 and the other electrical components of the vehicle 16. The presence of the transformer-rectifier can make the vehicle 16 substantially larger and heavier than a comparable DC-powered vehicle. The size and weight of the transformer-rectifier unit can be minimized, however, through the use of advanced power-conditioning electronics, and an aluminum-wound transformer with concentric windings. The size and weight of the transformer-rectifier also can be minimized by reducing the supply voltage of the AC power, in a trade-off between power-transmission efficiency, and the size and weight of the transformer-rectifier.

While high operating efficiencies can be achieved with operating voltages of 5,000 VAC to 15,000 VAC, voltages above 5,000 VAC can present a substantial electrocution hazard. Thus, an illustrative AC-based system may have a supply voltage of about 5,000 VAC; alternatively, the system can be configured to operate with a supply voltage of about 2,000 VAC, to facilitate the use of a smaller and lighter transformer-rectifier.

Due the electrocution hazard presented by the relatively high supply voltage of an AC-based system, a power-supplying system can be mounted above the roadway and the vehicle 16, in a manner similar to the overhead cable arrangements in high-speed rail systems. More specifically, a pair of overhead aluminum wires or cables, one for power and one for return, can be carried on insulated poles close to the TEV track 12. This is believed to the be simplest high-voltage power source for the system 10. For lowest cost and simplicity of maintenance, an AC-carrying cable of, for example, 12 kV AC may be a suitable choice; a higher of lower voltage can be used in the alternative, depending on the level of vehicle traffic. If the traffic level subsequently increases, a second power cable, or a larger power cable can be installed. Thus, flexibility is provided to adjust the available power to accommodate the actual traffic level, including growth in the traffic level.

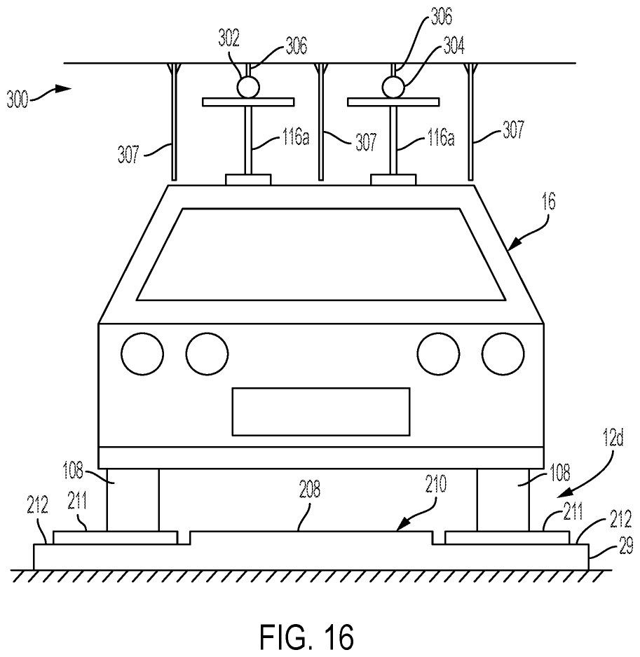

FIG. 16 is an illustrative example of such a system in the form of a system 300 that includes a first conductor in the form of a rod 302, and a second conductor in the form of a rod 304. The rods 302, 304 are suspended from the roof panel 204 of each track section 14, by way of electrically-insulating supports 306. The rods 302, 304 can be formed from, for example, aluminum or copper. Electrically-insulating barriers 307 are positioned between, and outward of the rods 302, 304. The barriers 307 prevent contact between the rods 302, 304, and partially shield the rods 302, 304 from contact with pedestrians. The rod 302 can supply electric power; and the rod 304 can act as a return, or ground.

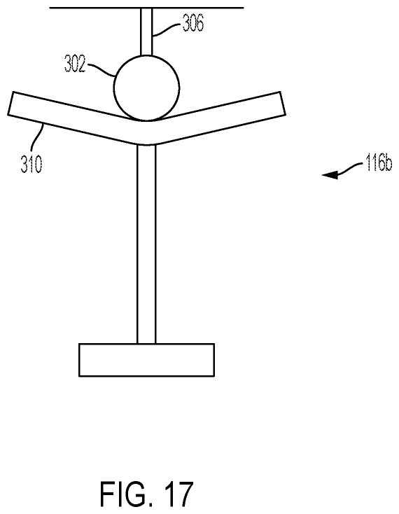

Electrical pickups 116a, similar to the electrical pickups 116, are mounted on the roof of the vehicle 16, and are configured to extend upward, so as to contact the rods 302, 304, when the vehicle 16 is on a TEV track of the system 300. FIG. 17 depicts an alternative embodiment of the electrical pickups 116a in the form of an electrical pickup 116b having Y-shaped brushes 310; the Y-shape of the brushes 310 helps the brushes 310 maintain contact with the power-supply cables as the vehicle 16 drifts from side to side during normal travel along the TEV track 12. Other alternative embodiments (not shown) can include U-shaped brushes, and brushes having other shapes.

The track sections 14 are narrower than the lanes of a conventional highway. The track sections 14 are relatively light, and thus can be stacked one on top of another in double-deck fashion using a suitable framework, thereby doubling the capacity the TEV track 12 for the same footprint on the ground. Also, the track sections 14 can be raised or elevated above the ground, so that the TEV track 12 does not interfere with human traffic or the migration paths of animals; to avoid natural and man-made obstacles; to help minimize the impact of the TEV track 12 on environmentally sensitive areas such as wetlands; etc.

Because the vehicle 16 has an alternative power source in the form of the battery 102, the entire TEV track 12 does not need to be electrified. The vehicle 16 can be operated on a non-electrified portion of the TEV track 12 using its battery 102 as the sole power source for the drive motor 100. For example, track sections 14 on a downhill portion of the TEV track 12 do not need to be electrified, as gravity can provide the primary motive force for the vehicle 16 on such downhill portions; and the vehicle 16 itself, powered by the battery 102 and/or its own momentum, can provide any additional motive force that may be required.

The vehicle battery 102 can be used to supplement the power provided by the TEV track 12 on uphill sections of the roadway, and on other localized portions of the roadway at which the vehicle power demand is relatively high. Thus, in contrast to trains, which in general have poor performance in climbing hills due to wheel spin, especially when wet leaves are present the tracks, the TEV track 12 can be configured so that the vehicle 16 maintains its speed and performance when climbing hills. The TEV track 12, therefore, can be installed on steeper grades than a high-speed railway system, which in some applications can eliminate the need for the tunnelling and extensive earth moving needed to maintain a relatively shallow grade. This advantage can be particularly valuable in the developing world, where there are many populated valleys located within high mountain ranges that preclude the use of trains, but could be served by the system 10. Also, the ability to supplement the power from the TEV track 12 using the on-board battery power of the vehicle 16 can eliminate the need for higher capacity, and more expensive, conductors on localized portions of the TEV track 12 at which the power demand is relatively high.

It is believed that the above-noted flexibility in locating the TEV tracks 12 can have substantial benefits. For example, railways have existed for about the past 200 years. Most rights-of-way, such as level ground alongside major rivers, already are in use by conventional railway systems in most developed countries. Therefore, the construction of new train tracks is expected to become even more difficult and more expensive. The system 10, by contrast, having little or no grade limitations, can be installed on desired routes regardless of whether the routes traverse hills, as is the case for motorways at present. Also, an elevated TEV track 14 can cross cultivated fields and built-up areas by being raised on columns, and the TEV tracks 14 can be arranged in a double-deck configuration to save space on busy bridges into and out of cities and other areas.

The entrances and exits 40 on the TEV track 12 are not electrified, to permit the vehicles 16 to freely enter and exit the roadway. In particular, the first and second rails 30, 32 are not installed at, or proximate the exits and entrances 40. For example, the first and second rails 30, 32 can be eliminated over a distance of about 200 meters (about 650 feet) at and near each entrance and exit 40, as shown in FIGS. 1 and 7. As a result of this feature, the upper surface of the base 29 is smooth and unobstructed at and near the entrances and exits 40, providing the vehicles 16 with an unobstructed path onto and off of the roadway.

A vehicle 16 can enter the TEV track 12 by driving onto the TEV track 12 by way of an entrance 40. The electrical pickups 116 of the vehicle 16 are maintained in their retracted, or stowed position, and the vehicle 16 is powered by its on-board battery 102 as the vehicle 16 enters the TEV track 12. Upon crossing onto the entrance 40, the vehicle 16 travels along a relatively short, non-electrified acceleration lane that forms part of the entrance 40. When positioned on the acceleration lane, the vehicle 16 can increase its speed prior to entering the TEV track 12. Once the vehicle 16 has entered onto the TEV track 12 and has advanced to a position where the vehicle 16 is positioned over the first and second rails 30, 32, the controller 18 can command the electrical pickups 116 to move into their deployed positions to establish electrical contact between the vehicle 16 and the TEV track 12, thereby allowing the vehicle 16 to draw power from the TEV track 12. The command to extend the electrical pickups 116 can be generated automatically by the control unit 112 of the vehicle 16; or by an input from the driver.

When the vehicle 16 is approaching an exit 40, the control unit 112 can command the electrical pickups 116 to move into their retracted positions. The command to retract the electrical pickups 116 can be generated automatically by the control unit 112; or by an input from the driver. Upon reaching the exit, the vehicle 16 can exit the TEV track 12 by driving across the unobstructed portion of the TEV track 12 resulting from the absence of the first and second rails 30, 32, and onto a relatively short, non-electrified deceleration lane that forms part of the exit 40. Once positioned on the deceleration lane, the vehicle 16 can reduce its speed through regenerative or other types of braking without slowing down or otherwise impeding the progress of the other vehicles 16 on the same TEV track 12; the vehicle 16 then can exit the TEV track 12 under its own momentum, and if necessary, under the power of its battery 102. Electric power regenerated by the vehicle 16 as it decelerates can be diverted to the battery 102 of the vehicle 16; into the TEV track 12 to power other vehicles 16; and/or to stationary batteries 312 (discussed below) located proximate the TEV track 12.

The system 10 can be equipped with provisions, discussed above in relation to the gap 209, that lift and then lower the electrical pickups 116 of vehicles 16 that are not entering or exiting the roadway as those vehicles 116 traverse the non-electrified portions of the roadway, to prevent damage to the brushes 118. The through-traffic vehicles 16 can continue ahead on their momentum, and if necessary, using their on-board batteries 102, until the vehicles 16 establish contact with the first and second rails 30, 32 on the other side of non-electrified portion of the TEV track 12. Also, the through traffic does not need to slow down to permit the exiting vehicles 16 to leave the TEV track 12. High-speed trains, by contrast, must repeatedly slow down and stop at different stations for several minutes or more, and need to reduce their speed when traveling on older sections of tack unable to handle the higher train speeds. Thus, although high-speed trains may travel at speed of up to 180 miles per hour (290 kilometers per hour), this speed advantage can be offset by the above factors. For example, vehicles 16 driving continuously at 120 miles per hour (193 kilometers per hour) will have an average speed similar to that of a high-speed train that can reach speeds of 180 miles per hour but must stop intermittently to pick up and discharge passengers. Also, because the vehicles 16 can operate on conventional non-electrified roadways, the vehicles 16 can transport their occupants to the occupants' final destination. A passenger train, by contrast, must stop and discharge passengers at a train station from which the passengers often need to take another mode of transportation to their final destination.

In multi-lane systems such as the system 15 shown in FIG. 7, non-electrified transfer points 42 can be provided at intervals along the various TEV tracks 12 to facilitate lane changes by the vehicles 16. This feature can provide the central controller 18 with flexibility to direct vehicles 16 to different lanes, i.e., onto different TEV tracks 12 carrying vehicles in the same direction, so as to manage the traffic flow within the system 15. This feature also permits the vehicles 16 to enter and exit the system 15 by way of a single series of entrances and exits 40 that adjoin only one of the lanes.

As another example of non-electrified portions of the TEV track 12, minor portions of the TEV track 12 that interconnect major portions of the TEV track 12 and run several miles or more in length can be non-electrified. The vehicles 16 can traverse such minor sections using power from their battery 102, and/or their own momentum. The non-electrification of such light-duty portions of the TEV track 12 can eliminate the need to equip those portions with electrical conductors such as the first and second rails 30, 32, thereby reducing the overall cost of the TEV track 12.

Upon reaching, or returning to, an electrified portion of the TEV track 12, the vehicle 16 can draw its electric power from the TEV track 12 by way of the first and second rails 30, 32; and the battery 102 can be recharged by the electric power being drawn from the TEV track 12. Because the battery 102 is used as a secondary power source when the vehicle 16 is operating on the TEV track 12, the battery 102 does not need to be recharged immediately; hence, the charging process can occur relatively slowly, avoiding the inefficiencies and energy losses associated with fast charging.

Also, in contrast to a roadway system which is electrified intermittently in discrete sections spaced apart in a consistent, repetitive manner, most of the TEV track 12 is electrified. Consequently, most of the energy drawn by the vehicle 16 during long-distance cruise and other operating conditions is used directly by the drive motor 100; and little if any energy is lost to the recharging process for the battery 102. In an intermittently-electrified roadway, by contrast, the battery is constantly undergoing a discharge-recharge cycle. This can result in substantial energy losses associated with the recharging process, can reduce the service life of the battery 102, and can necessitate a larger and heavier battery 102 than otherwise would be needed.

The TEV track 12 can be equipped with specially-configured sections that can provide a relatively large amount of power to the vehicles 16 traveling along those sections. These specially-configured sections can act as superchargers that permit fast charging of the batteries 102 of the vehicles 16, without the need for the vehicles 16 to stop at a conventional stationary supercharging station. The additional power capacity can be provided, for example, by adding more power supplies 310 near the fast-charging sections of the TEV track 12.

The central controller 18 comprises a processor, such as a microprocessor; a memory device communicatively coupled to the processor via an internal bus; and computer-executable instructions stored on the memory device and executable by the processor. The controller 18 also comprises an input-output bus, and an input-output interface communicatively coupled to the processor by way of the input-output bus. The computer-executable instructions are configured so that the computer-executable instructions, when executed by the processor, cause the controller 18 to carry out the various logical functions described herein.

The TGV high-speed rail system currently uses twin 15 mm copper wires rated at 25 k VAC to power the train via a single pantograph located on the roof of the power car. The TGV system does not need a separate return line, because the return occurs by the welded steel rails on which the train travels. While this arrangement is satisfactory, it is well not suited to the system 10. A high-voltage line just above the roof of the vehicle 16 could present an electrocution risk, and a pantograph on the roof of a car may appear unsightly.

Older, and relatively slow electric trains traditionally have been powered by 750 VDC or similar voltages, with the power conductor rail being located on a support frame next to the steel rails on which the train travels. The electrical circuit is completed via the motors and axles of the train, and the grounded steel rails. The usable voltage between substations of such systems has been characterized as a “bathtub curve,” which can lead to the inefficient use of electric power if the distances between substations become too great. And multiple trains on the same track add to this problem. Due to its configuration, the system 10 does not have these problems.

The system 10 must first connect, for example, with a pair of overhead 12 k VAC or other high voltage power lines, and then transform and rectify that voltage to a lower, safer level using the power supplies 310. As noted above, 750 VDC generally is considered to be safe for use by a train, but a higher voltage may be acceptable for the system 10 if adequate safety features are provided on the vehicles 16 and elsewhere in the system 10. Therefore, no limits on the operating voltage of the system 10 are implied herein.

The first and second conductors 30, 32, in theory, can be installed in virtually any position at which the vehicle 16 can make contact with the first and second conductors 30, 32. As discussed above, however, it is preferable to position the first and second conductors 30, 32 under the vehicles 16, out of sight and out of touching range. Another placement option is to ground (to earth) or not ground the first and second conductors 30, 32 for safety reasons.

The doors and windows of the vehicles 16 automatically will remain closed and locked while the vehicles 16 are on the TEV track 12, to reduce or eliminate the potential for occupants of the vehicles 16 to come into contact with the first and second conductors 30, 32. Opening the doors and windows of the vehicle 12 will be permitted only if power to the TEV track 12 is disconnected. The windows will not open more than a crack while the vehicles 16 are underway on the TEV track 12.

Each vehicle 16 can operate exclusively on its on-board battery 102 during non-cruising maneuvers, such as when the vehicle 16 exits one TEV track 12 and travels along a non-electrified roadway before entering another TEV track 12 miles away. Also, the vehicle 16 can drive itself automatically off the TEV track 12, and then drive the occupants to their final destination on a non-electrified roadway while being powered exclusively by the battery 102, thereby eliminating the need for a station or other transfer point between the TEV track 12 and an adjoining, non-electrified roadway. Also, the vehicles 16 can be configured to automatically draw some, or all of their power from their on-board batteries 102 if the voltage available from the TEV track 12 becomes depressed due to heavy traffic, insufficient power from the electric utility, technical issues within the system 10, etc. The batteries 102 subsequently can be recharged, for example, when the operating voltage of the TEV track 12 returns to normal levels.

It is believed that the significant savings in capital cost that can be achieved through the use of the mass-produced power supplies 310, and other aspects of the system 10, can make the system 10 especially attractive to investors, and to the governments of poorer nations that cannot afford the high capital cost of a high-speed railway system. Also, it is believed that a single TEV track 12 can carry at least ten times as many passengers as a passenger railway train system because the vehicles 16 of the system 10 do not need to stop at stations of other transfer points; and the system 10, unlike railway systems, can operate efficiently on a continuous, around-the-clock basis due, for example, to its low staffing requirements.

The power generation plants of electrical utilities often have surplus power during nighttime hours, but not during the day. The system 10 can be configured to store energy produced by power plants or other sources at night or during other times of off-peak demand. The energy can be stored, for example, in large, stationary batteries 312 located in, or near the power supplies 310. One of the batteries 312 is depicted in FIG. 2. The batteries 312 can be charged, for example, with excess electrical energy produced by the electrical utility company during non-peak hours of electricity usage, such as at night. This storage capacity can be used to reduce the draw of the system 10 from the electrical grid during periods of peak electrical demand and peak electric costs, without requiring the vehicles 16 to draw power from their on-board batteries 102. Also, if rush-hour traffic volume results in excessive power requirements by the system 10, the demand on the power grid can be reduced through the use of the standby batteries 312, and if necessary, the batteries 102 of the individual vehicles 16.

Considering that a primary purpose of the system 10 is to reduce greenhouse gases in the atmosphere, the use of the storage batteries 312 to reduce the demand for electricity during peak hours can provide another opportunity to contribute to such reductions. The batteries 312 also can be used as a backup power source in the event of a power outage on the part of the utility company. The weight of the stationary batteries 312 is irrelevant in this particular application, because the batteries 312, once installed, do not have to be moved. Therefore, low-cost lead-acid batteries may be a favorable option over more expensive lithium batteries. Recycled lithium batteries, taken from used electric vehicles, also may provide a cost-effective option for use as the stationary batteries 312.

The system 10 also can help address the problem of surplus power availability during off-peak hours by encouraging night charging for electric vehicles. Currently-available home chargers are relatively slow or expensive, so rapid charging normally will be done while the vehicles 16 are operating on the TEV tracks 12 of the system 10. In addition to the option of charging vehicles 16 on the TEV tracks 12, there is an intermediate opportunity for many cooperating houses in a neighborhood to share one or more communal high-current chargers, with charging of the various vehicles 16 being conducted on a sequential basis, preferably during off-peak hours.

The system 10 can be configured to operate in a “power sharing” mode. In this mode, the system 10 can draw, or “borrow” a limited amount of energy from well-charged batteries 102 on vehicles 16 that are operating on the TEV track 12, to make up, at least in part, for excess demand from other vehicles 16. The owners or operators of the vehicles 16 from which electric power is borrowed can be reimbursed in energy units at a later time. This arrangement uses some of the enormous amount of potential energy that is stored collectively in the well-charged batteries 102 of the vehicles 16 to power other vehicles 16 during excessive demand periods, or at other times when the available power supply is inadequate for the demand. The system 10 thus can substantially limit the consumption of relatively expensive power that needs to be delivered to the TEV track 12 during peak periods of electrical demand. This benefit can be achieved with virtually no increase in the capital cost of the system 10. And the power sharing concept potentially can reduce capital cost of the system 10, because fewer power supplies 310 will be needed to meet the peak power demands of the system 10 that occur, for example, during rush hours.

Power sharing can be implemented administratively by requiring the operators of all vehicles 16 traveling on the TEV track 12 to agree contractually that, upon demand, their vehicle 16 will share a moderate amount of energy from its battery 102 from time to time during periods of high power demand, or under other circumstances in which the electric power available to the system 10 is not sufficient to meet the power demand. The contract between the operators of the vehicles 16 and the operators of the system 10 can result in a unique power sharing agreement that benefits the operators of both the vehicles 16 and the system 10.

It is believed that power sharing will need to be implemented in countries and regions throughout the world in which the local electric utilities have inadequate capacity to provide sufficient electric power to their respective customers.

In addition to, or in lieu of power sharing, the operator of the system 10 can mandate that all vehicles 16 use their own batteries 102 during periods of high power demand. In such a scenario, the TEV track 12 would draw power only from vehicles 16 with batteries 102 having a relatively high level of charge.

Power sharing potentially can result in an increase in the amount of traffic that the TEV track 12 can accommodate for a given amount of power available from the electric utility. Also, it is believed that power sharing can make the system 10 more economical for its users, and can yield a higher return on capital for investors in the system 10. Power sharing also can help to tailor and optimize the power-distribution to all vehicles 16 operating on the TEV track 12 based on the specific need of each vehicle 16, taking into account the local traffic density, the collective energy stored in the batteries 102 of all the vehicles 16 operating on the TEV track 12, and the planned and calculated energy consumption of these vehicles 16.

The main beneficiaries of power sharing likely will be vehicles 16 concentrated in urban areas during rush hour periods. Vehicles passing through these urban areas and “donating” electric power to the system 10 will have their batteries 102 recharged by the system 10 once the vehicle 16 no longer is in an area in which the electric supply to the TEV track 12 is insufficient to meet the demand at a particular time.

In one possible scenario, the central controller 18 can be programmed to implement power sharing by: (1) eliminating the use of electric power from the TEV track 12 by well charged vehicles 16 by electrically disconnecting those vehicles 16 from the TEV track 12 for a short period of time; (2) drawing power from the large, stationary storage batteries 312 located next to the TEV track 12; and (3) drawing electric power from the batteries 102 of the “herd” of vehicles 16 which are on the TEV track 12 and to which power later can be replaced automatically and free of charge by the system 10. The central controller 18 can receive the charge state of each vehicle 16 on the TEV track 12 from control unit 112 of the vehicle 12 via the vehicle's transceiver 114.

The vehicle 16 can control the charging or discharging of its battery 102 in response to commands received by the control unit 112 from the central controller 18, to implement power sharing and other controlled charging and discharging of the vehicle's battery 102. More specifically, the control unit 112 can issue commands to a power regulator or other charging circuitry (not shown) in the vehicle 12 to control: the rate at which the battery 102 draws electric power from the TEV track 12 via the first rail 30 during charging; and the rate at which the battery 102 discharges electric power to the TEV track 12 during discharge.

In the course of time, as electrical energy becomes universally available for long journeys through electrified roadways such as the system 10, and the storage capacity of batteries increases, the large traction batteries of current electric vehicles no longer will be needed, and such batteries can be replaced by lighter and more compact batteries. The resulting decreases in vehicle weight can result in lower power consumption, better overall energy efficiency, and lower cost of travel.

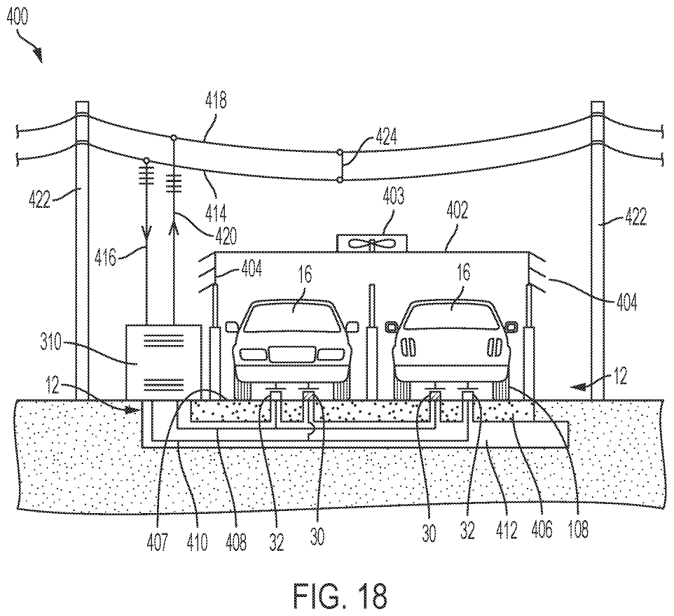

FIG. 18 depicts an alternative embodiment of the roadway system 10, in the form of a roadway system 400. The system 400 is substantially similar to the system 10. Components of the system 400 that are substantially the same as those of the system 10 are denoted using identical reference characters.

The system 400 includes a substantially airtight housing 401. The housing 401 is equipped with one or more exhaust fans 402. The fans 402 partially evacuates air inside of the housing 401, to help reduce aerodynamic drag on the vehicle 16. The housing 400 also includes high vents 404 that can be used to vent smoke from the housing 401 during, for example, a fire. The fans 402 also can be used to vent smoke from inside the housing 401 in the event of a fire within the housing 401.

The system 400 includes a road base 406. The road base 406 can be formed, for example, from concrete or another heavy material, to help absorb and dampen vibration from the passage of the vehicles 16 at high speed over the road base 406. The road base 406 can be formed from other types materials in alternative embodiments. The tires 108 of the vehicles 16 rest directly on, and rotate along an upper surface 407 of the road base 406.

The system 400 includes a plurality of the power supplies 310. As explained above in relation to the system 10, the power supplies 310 receive relatively high voltage AC electric power from the power grid, and reduce and rectify the AC power to a lower-voltage DC power suitable for safely powering the vehicles 16. Each power supply 310 is electrically connected to the first and second rails 30, 32 of the TEV track 12 by a respective positive power cable 408 and a negative return cable 410. The cables 408, 410 are routed beneath the upper surface 407 of the road bed 406, via a trench 412 formed in the road bed 406.

The power supply 310 receives the high-voltage AC power from an overhead high-voltage utility power line 414, via a high-voltage supply lead 416. The opposite pole of the power supply 310 is electrically connected to an overhead return utility power line 418, via a high-voltage return lead 420.

The utility power line 414 and the return utility power line 418 are suspended from insulated poles 422. Slack is provided in the utility power line 414 and the return utility power line 418, to allow for contraction in cold weather, without the need to adjust the tension in the utility power line 414 and the return utility power line 418. For purposes of illustration, the poles 422 are shown in FIG. 18 as being located on opposite sides of the TEV track 12; and the utility power line 414 and the return utility power line 418 are shown as extending in a direction perpendicular to the TEV track 12. The poles 420 normally are located on the same side of the TEV track 12; and the utility power line 414 and the return utility power line 418 normally extend in a direction parallel to the TEV track 12. In alternative embodiments, ceramic supports integrated into the track structure, in conjunction with other properly insulated components, can be used in lieu of the poles 420. Separation between the utility power line 414 and the return utility power line 418 is maintained by an insulated spacer 424.

e. Operation

As discussed above, each vehicle 16 operates autonomously, under the control and without input from the driver, whenever the vehicle 16 is traveling on the TEV track 12. Because the controller 18 can simultaneously control the respective positions of all the vehicles 16 operating on the TEV track 12, the spacing between vehicles 16 operating in the same lane, i.e., on the same TEV track 12, can be minimal, while still maintaining a high standard of safety. For example, it is believed that the controller 18 can safely maintain a back-to-front spacing of about 24 inches (about 61 cm) under dry road conditions, and at speeds of about 60 miles per hour (96 kilometers per hour) to about 120 miles per hour (193 kilometers per hour), depending on whether a particular TEV track 12 is being used for express or local travel.

The ability to safely operate the vehicles 16 in close proximity to each other permits the vehicles 16 to be operated in tightly-spaced groups in the form of, for example, ten-vehicle platoons or 30-vehicle convoys. As an example, FIG. 7 depicts a platoon traveling along the high-speed TEV track 12a (only six of the ten vehicles 16 in the platoon are shown in FIG. 7, for illustrative clarity). Operating multiple vehicles 16 in this manner can substantially reduce the aggregate air resistance of the vehicles 16, thereby reducing the overall energy consumption of the platooned or convoyed vehicles 16. For, example, it is estimated that operating the vehicles in a platooned or convoyed manner can produce an overall reduction in aerodynamic drag, and energy consumption, of about 40 percent. Also, because it is highly unlikely that vehicles 16 traveling at the same speed and in the same direction will collide with each other, operating the vehicles 16 in a platooned, convoyed, or other grouped manner can enhance the safety of travel on the TEV track 12. Thus, it is believed that such grouped operation will become routine over time.

Also, operating the vehicles 16 in platoons, convoys, or other closely-spaced groupings can substantially increase the traffic-carrying capacity of the TEV track 12. For example, if the fast lane of a normal three-lane highway were converted to an electrified TEV track 12 carrying only the autonomously-controlled vehicles 16, the TEV track 12 would be able to carry at least ten times more vehicles 16 than each of the conventional non-electrified lanes. This would allow the modified three-lane highway, i.e., a highway made up of three TEV tracks 12, to carry as much traffic as a conventional twelve-lane highway. Also, the incremental cost of providing the TEV track 12 with the capacity to accommodate platoons, convoys, or other vehicle groupings is relatively low, since the only required modification is the addition of more power supplies 310 to handle the increase in the localized power requirements needed to accommodate multiple vehicles accelerating simultaneously to cruising speed.

The need for additional power capacity to accommodate convoyed or other grouped operation can be minimized by using the on-board battery power of the vehicles 16 to supplement the power supplied by the TEV track 12 during the relatively short, multi-vehicle acceleration period. For example, it is believed that convoys of ten vehicles 16 accelerating together from zero to 120 mph will draw about one-half megawatt of electric power over a short length of an entry lane. The use of the vehicle batteries 102 to supply at least some of this power can eliminate the need to provide the entry lane with the capacity to provide such a disproportionately high level of power. Alternatively, the system 10 can be configured with high-voltage AC power, such as 12 k VAC, 24 k VAC or 50 k VAC, to provide sufficient capacity for grouped vehicle operation.

As noted above, it is believed that the vehicles 16 can be operated in a platooned, convoyed, or other grouped manner, under dry road conditions, at speeds of up to 120 miles per hour (193 kilometers per hour) on individual TEV tracks 12 dedicated to long-distance or express travel; and at speeds of up to 60 miles per hour (96 kilometers per hour) on TEV tracks 12 dedicated to shorter distance or local travel. These speeds can be reduced automatically, and in real-time, by the central controller 18 when road conditions are wet, snowy, or icy; or when maintenance, accidents, or other factors warrant reduced speeds.

The vehicle 16 can transmit its desired destination to the central controller 18 via the transceivers 33, 114. The vehicle 16 can include a user interface 160 communicatively coupled to the control unit 112, as shown in FIG. 6. The user interface 160 permits the driver or other user to input the destination and other information into the control unit 112, and to monitor the position and other status information for the vehicle 16. The user interface 160 can be, for example, a keypad and a display. In addition, the control unit 112 can be configured to receive inputs from, and provide status information to a remote device, such as a smart phone, via a wi-fi or cellular connection.

The vehicle 16 can be driven onto the TEV track 12 using the power supplied by its internal battery 102, in substantially the same manner as when entering a conventional highway. The entrances 40 to the TEV track 12 can be equipped with a barrier, such as a gate 150, for preventing conventional vehicles from gaining access to the TEV track 12. The gate 150 is depicted in FIGS. 2 and 6.

The gate 150 also can be used to deny access to vehicles 16 that are not properly configured for use on the TEV track 12, such as vehicles 16 equipped with external luggage racks, pods, or other drag-inducing devices; vehicles 12 hitched to trailers; and pickup trucks with open beds, which can induce high levels of drag and raise safety concerns relating to unrestrained items flying out of the open bed at high speeds. In one possible operating scenario, vehicles 16 with weak or discharged batteries 102, as determined by the vehicles' charge state relayed to the central controller 18, may be prohibited from entering the TEV track 12 until the battery 102 has been charged sufficiently. Rapid charging can be accomplished, for example, by a supercharging section, as described above, located near the entrance to the TEV track 12.

The central controller 18 can assume control of the vehicle 16 as the central controller 18 commands the gate 150 to open. The controller 18, through inputs to the control unit 112, can guide the vehicle 16 onto the TEV track 12 in a manner that maintains separation between the vehicle 16 and the other vehicles 16 operating on the TEV track 12. The control unit 112 of the vehicle 16 can command the electrical pickups 116 to extend so that the attached brushes 118 contact the respective first and second rails 30, 32 once the electrical pickups 116 have aligned with the first and second rails 30, 32. The controller 18, via inputs to the control unit 112, subsequently can the guide the vehicle 16 so as to position the vehicle 16 in a platoon, convoy, or other type of grouping with other vehicles 16.

Because the vehicle 16 draws its power from the TEV track 12, and the driver does not need to drive or otherwise control the vehicle 16, the vehicle 16 in theory can travel an unlimited distance at high speeds, without stopping, and with a high degree of safety, in contrast to gasoline-powered vehicles, and current electric vehicles the rely on batteries as their sole power source. From a practical standpoint, however, the non-stop range of the vehicle 16 is dictated by the needs of the driver and passengers for rest stops. In scenarios where the vehicle 16 is being ferried without a driver or passengers, the vehicle 16 can make a cross-country or other long-distance trip under the autonomous control of the central control unit 112, without stopping.

As the vehicle 16 reaches the exit 40 corresponding to its destination, the control unit 112 can command the electrical pickups 116 to retract; and the central controller 18, through inputs to the control unit 112, can guide the vehicle 16 to, and through the exit 40 in the manner described above. Because the vehicle 16 operates on conventional rubber or synthetic rubber automobile tires 108 without the use of rails, the exiting procedure is substantially equivalent to exiting a regular highway; and the exit can be performed without the use of complicated hardware like railway switches or points. Once the vehicle 16 has exited the TEV track 12, the vehicle 16 can be driven to its final destination under semi-autonomous control, or under fully manual control exercised by the driver.

In general, the cost of electricity supplied by electric utility companies is lower at night and during other off-peak hours. This lower cost can be passed on to the users of the system 10 through reduced operating charges an night and during other off-peak times. It is believed that such a discount in operating costs will incentivize drivers to travel and/or to charge their vehicles' batteries 102 during non-peak hours. For example, commercial vehicles, such as light freight vehicles, can be programmed to time their recharging to occur during at off-peak hours. The resulting reduction in electricity demand during peak hours, in turn, can lead to further increases in the overall efficiency with which electricity is generated and distributed by the utility company. Also, it is believed that the night-time discount in operating costs will encourage long distance travel at night on express tracks of the system 10, due to a much lower cost per mile than air travel. This can produce a double benefit because displacing air travel can help reduce the substantial amounts of CO₂ currently produced by civil aircraft.

The electrified TEV track 12 is believed to among the most efficient ways to propel electrically-powered vehicles “on the fly,” and thus has the potential to achieve substantial reductions in CO₂ emissions world-wide, notwithstanding that reducing CO₂ emissions from highway vehicles is a relatively difficult problem because motorized vehicles, by their nature, are mobile.

The cost of the electricity consumed by the vehicle 16 can be monitored and recorded by the central control unit 112 or other suitable means. The electricity cost can be automatically billed to, and paid by the owner of the vehicle 16, as in systems now in use on toll roads. Also, the ability to draw electric power from the TEV track 12 eliminates the need to fill up a gasoline tank at a gas station, and the need to stop to recharge the battery 102 using a stationary charger.

The system 10 provides users with the ability to drive from home to a local entrance 40 for the TEV track 12 in the family car, i.e., the vehicle 16. Once travel is established on the TEV track 12, the driver and passengers can sleep while the vehicle 16 cruises safely at, for example, 120 miles per hour (193 kilometers per hour) for hundreds of miles. The driver and passengers can be woken up in time for a programmed exit from the TEV track 12. The remainder of the journey can be driven manually over non-electrified secondary roads to the final destination. In many if not all cases, it is believed that a door to door journey using the TEV track 12 will be quicker than that of a high-speed train, which typically is restricted to travel between a relatively small number of terminals located in large cities. Moreover, because the system 10 facilitates travel by small numbers of people in individual vehicles 16, it is believed that travel on the system 16 will be more comfortable, more convenient, quieter, and more hygienic than train travel. Also, occupants of the vehicles 16 operating on the TEV track 12 will not need to share the same enclosed space with sick strangers, potentially reducing the risk and probability of pandemic diseases dramatically.

Although the TEV track 12 is configured to accommodate the electric vehicles 16, vehicles powered by internal combustion engines also can operate on the TEV track 12, if such vehicles are configured to be autonomously controlled by the central controller 18; and subject to restrictions against operating in portions of the TEV track 12, such as tunnels, that may not be sufficiently ventilated to remove the exhaust gases generated by the internal combustion engines. As noted above, allowing vehicles powered by internal combustion engines to use the TEV track 12 can be implemented, for example, as a temporary measure to increase toll revenue during the early stages of operation of the TEV track 12.

It is believed that overall travel times on the TEV track 12 will be comparable to, or more favorable than those of high-speed trains. This is due, in part, to the ability to economically decentralize the TEV track 12 to reach a relatively large number of destinations, in comparison to the relatively limited number of centralized stations typically available to a high-speed rail system; and because the vehicles 16, after leaving the TEV track 12, can be driven directly to their final destinations using the internal battery 102 as their power source. Also, unlike most if not all high-speed rail systems, it is believed that the construction and operating costs for the TEV track 12 can be recovered entirely through toll revenues.

The TEV track 12 can accommodate both private and public service vehicles that meet the safety and size requirements for the TEV track 12. The vehicles 16 can be owned and operated by individuals; and by commercial enterprises such as taxi companies, courier delivery services, etc. Government ownership may be preferred in some countries, but private capital would generally be a preferred option in most of the world.

Due to the automated operation and modular construction of the TEV track 12, it is believed that the number of employees required to operate and maintain the TEV track 12 is a small fraction of that required by a rail system or a major highway system; this obviates the need to rely on large government-run agencies to maintain the TEV track 12 in an operational condition. Although government ownership for the TEV track 12 may be preferred in some countries, it is believed that funding by private capital, or public-private partnerships, would be the preferred option for initial funding in most of the world, with return revenue being generated by tolls once the TEV track 12 becomes operational.

In applications where the TEV track 12 is subject to an initial start-up and acceptance period, the first and second rails 30, 32 initially can be made relatively thin, to save costs. As time passes and more vehicles 16 begin to use the TEV track 12, the first and second rails 30, 32 be strengthened and made more durable by bolting on or otherwise adding more conductor material to the first and second rails 30, 32; or, in applications using modular rails such as the first and second rail 30b, 32b, by adding more electrically-conductive elements.

All, or portions of the TEV track 12 may be enclosed, and air may be partially or fully evacuated from the enclosed volumes to reduce aerodynamic drag on the vehicle 16 and thereby save energy. Air also can be evacuated from underground tunnels traversed by the TEV track 12. The interior of the vehicle 16 can be pressurized for passenger comfort as the vehicle 16 passes through areas in which the air has been evacuated.

If a particular vehicle 16 breaks down, has a low battery-charge state preventing operation the vehicle 16, or otherwise stops running on the TEV track 12, the central controller 18 can direct the vehicle or vehicles 16 located behind the disabled vehicle 16 to push the disabled vehicle 16 to the next exit 40, so that the disabled vehicle 16 can be removed from the TEV track 12 and repaired. The vehicles 16 can be equipped with bumpers to facilitate pushing other vehicles 16 in this manner. This feature can help eliminate delays caused by disabled vehicles 16.

It is estimated that the vehicles 16 can come to a complete stop on the TEV track 12 in about 50 yards (46 meters), from a speed of 120 miles per hour (193 kilometers per hour) and under dry road conditions. High-speed trains such as the Japanese Shinkansen, by contrast, have a published stopping distance of up to 2.5 miles (4,000 meters). Thus, even if a portion of the TEV track 12 located 100 yards (91 meters) from a platoon or convoy of the vehicles 16 was intentionally or unintentionally damaged or blocked, the lead vehicle 16 in the platoon or convoy could brake heavily and stop well before the damaged section. Even if a vehicle 16 did reach a damaged or blocked portion of the TEV track 12, it is believed that the many effective safety features of modern automobiles, such as a one-g deceleration rate, anti-lock brakes, safety belts, airbags, and energy absorbing crumple zones, etc. would protect the vehicle occupants from serious harm. By contrast, high-speed trains generally are not equipped with such features to protect passengers in the event of a crash.

The direct-current power supply of the system 10 is relatively simple, and utilizes existing technologies. Therefore, the system 10 can be implemented relatively quickly, thereby allowing major countries around the world to reduce their CO₂ production from cars and similar vehicles relatively quickly. This is particularly significant in view of the present failure of hydrogen power to provide the earlier-predicted reductions in CO₂ emissions.

1-28. (canceled)

29. An electrified roadway system, comprising:
a roadway comprising a base, an electrically-conductive first rail mounted on the base, and an electrically-conductive second rail mounted on the base, wherein the first rail is configured to be electrically connected to a source of electric power, and the second rail is configured to be electrically connected to an electrical ground;
a vehicle comprising a plurality of non-electrically-conductive tires; an electric motor mechanically connected to, and configured to rotate at least one of the tires to propel the vehicle along the roadway; a rechargeable battery electrically coupled to the electric motor and configured to power the electric motor; and a first and a second electrical pickup each being electrically connected to the electric motor and being configured to contact the respective first and second rails when the vehicle is located on the roadway, wherein the battery is configured to receive electric power from the first rail by way of the first electrical pickup; and
a controller configured to regulate an amount of electric power supplied to the vehicle by way of the first rail based, at least in part, on a charge state of the battery of the vehicle.

30. The system of claim 29, wherein:
the vehicle further comprises a control unit communicatively coupled to the controller, and charging circuitry communicatively coupled to the control unit and electrically connected to the battery; and
the control unit and the charging circuitry are configured to regulate the amount of electric power supplied to the vehicle by way of the first rail response to a first input from the controller.

31. The system of claim 30, wherein the charging circuitry comprises a power regulator.

32. The system of claim 30, wherein the battery is further configured to supply electric power to the first rail by way of the first electrical pickup.

33. The system of claim 32, wherein the control unit and the charging circuitry charging circuitry are further configured to regulate an amount of electric power supplied by the vehicle to the first rail in response to a second input from the controller.

34. The system of claim 33, wherein the first and second inputs are based, at least in part, on an overall demand for electric power on at least a portion of the roadway system.

35. The system of claim 34, wherein the first and second inputs aRE based, at least in part, on an overall demand for electric power on a portion of the roadway system on which the vehicle is located, and the charge state of the battery.

36. The system of claim 30, wherein the controller is further configured to interrupt the supply of electric power to the vehicle by way of the first rail based, at least in part, on the overall demand for electric power on at least a portion of the roadway system, and the charge state of the battery.

37. The system of claim 36, wherein the controller is further configured to interrupt the supply of electric power to the vehicle by way of the first rail by generating an input that, when received by the control unit, causes the control unit to physically disconnect the first pickup from the first rail.

38. The system of claim 36, wherein the controller is further configured to electrically disconnect the vehicle from the first rail when a power demand of the roadway system exceeds a predetermined threshold and a charge state of the battery exceeds a predetermined level.

39. The system of claim 29, wherein the battery is configured to be recharged by the electric power received from the first rail by way of the first electrical pickup.

40. The system of claim 29, wherein:
the vehicle comprises a plurality of vehicles; and
the controller is further configured to regulate amounts of electric power supplied to or drawn from the vehicles by way of the first rail based at least in part on: a need for electric power of each of the vehicles; a collective amount of energy stored in the batteries of the vehicles; and a collective energy consumption of the vehicles.

41. The system of claim 29, wherein: the vehicle is a first vehicle; the system further comprises a second vehicle; and the controller is further configured to regulate a transfer of electric power from the first vehicle to the second vehicle by way of the first rail.

42. The system of claim 29, further comprising a stationary battery electrically connected to the first rail; wherein the controller is further configured to regulate an amount of electric power supplied to the first rail by the stationary battery.

43. The system of claim 42, wherein the controller is further configured to regulate the amount of electric power supplied to the first rail by the stationary battery based, at least, on a demand for electric power on at least a portion of the roadway system.

44. The system of claim 43, wherein the controller is further configured to regulate the amount of electric power supplied to the first rail by the stationary battery based, at least in part, on the demand for electric power on at least a portion of the roadway system, and the charge state of the battery.

45. The system of claim 29, wherein the vehicle further comprises a transceiver configured to communicatively couple the control unit and the controller.

46. The system of claim 29, further comprising one or more power supplies electrically connected to the source of electric power and the first and second rails, wherein the power supplies are configured to rectify and reduce a voltage of electric power from the source of electric power.

47. The system of claim 46, the power supplies are configured to rectify and reduce the voltage of electric power from the source of electric power to about 400 volts to about 750 volts.

48. The system of claim 47, wherein the vehicle further comprises a converter electrically connected to the first electrical pickup and the electric motor and configured to, during operation, convert a voltage of electric power from at least one of the power supplies to an operating voltage of the electric motor.
